(19) United States
(12) Patent Application Publication
(10) Pub. No.: US 2016/0321125 A1
(43) Pub. Date: Nov. 3, 2016

(54) SELF-DIAGNOSIS DEVICE AND DEVICE INCLUDING THE SAME

(71) Applicant: SAMSUNG ELECTRONICS CO., LTD., SUWON-SI (KR)

(72) Inventors: BO GYEONG KANG, SEOUL (KR); SANG HWA JIN, SEONGNAM-SI (KR); DAE HWAN KIM, YONGIN-SI (KR); MYUNG KOO KANG, SEOUL (KR); JAE WOO JUNG, CHEONAN-SI (KR); HYUN WOO CHUNG, YONGIN-SI (KR)

(21) Appl. No.: 15/142,315

(22) Filed: Apr. 29, 2016

Related U.S. Application Data
(60) Provisional application No. 62/155,098, filed on Apr. 30, 2015.
(60) Provisional application No. 62/185,893, filed on Jun. 29, 2015.

(30) Foreign Application Priority Data
Jul. 20, 2015 (KR) 10-2015-0102303

(51) Int. Cl. G06F 11/07

(52) U.S. Cl. CPC G06F 11/079; G06F 11/0751; G06F 11/0772

(57) ABSTRACT

A semiconductor device includes a component and a self-diagnosis device. The self-diagnosis device includes a hardware secure module and a processor. The hardware secure module is configured to store a self-diagnosis policy for the component. The processor is configured to receive a detection signal output from a sensor, to diagnose a state of the component using the detection signal and the self-diagnosis policy stored in the hardware secure module, and to generate a control signal for controlling the state of the component according to the diagnosed state.

### CROSS-REFERENCE TO RELATED APPLICATIONS

This application claims priority under 35 U.S.C. §119(e) to U.S. provisional patent application No. 62/155,098, filed on Apr. 30, 2015 and U.S. provisional patent application No. 62/185,893, filed on Jun. 29, 2015, in the U.S. Patent and Trademark Office. This application further claims priority under 35 U.S.C. §119(a) to Korean Patent Application No. 10-2015-0102303, filed on Jul. 20, 2015, in the Korean Intellectual Property Office, the disclosures of which are incorporated by reference herein in their entirety.

### TECHNICAL FIELD

Exemplary embodiments of the present inventive concept relate to an electronic device, and more particularly, to a self-diagnosis device and, a device including the same.

### DISCUSSION OF THE RELATED ART

When an error or malfunction occurs to a product, a customer may contact an after-sales service (AS) center managed or run by a manufacturer of the product to explain the error or malfunction of the product. In response, a staff of the AS center may first visit a customer's site where the product is installed to accurately figure out the abnormality of the product, and may, however, need to make another visit the customer's site if the staff does not have a replacement part.

### SUMMARY

According to an exemplary embodiment of the present inventive concept, a semiconductor device is provided. The semiconductor device includes a component and a self-diagnosis device. The self-diagnosis device includes a hardware secure module and a processor. The hardware secure module is configured to store a self-diagnosis policy for the component. The processor is configured to receive a detection signal output from a sensor, to diagnose a state of the component using the detection signal and the self-diagnosis policy stored in the hardware secure module, and to generate a control signal for controlling the state of the component according to the diagnosed state.

The hardware secure module may store a digital signature of a user of the semiconductor device. The processor may be configured to generate a diagnosis report including the digital signature according to the diagnosed state.

The self-diagnosis policy may include at least two among a sensing type, a sensing method, a condition, or a cure activity. The processor may be configured to generate a diagnosis report including at least one among an abnormal symptom of the component or an expected replacement time of the component.

The semiconductor device may further include a communication module. The communication module may be configured to transmit the diagnosis report generated by the processor to an external communication device.

The semiconductor device may further include a display driver. The processor may be configured to generate a second diagnosis report including at least one among an abnormal symptom of the component or an expected replacement time of the component based on the diagnosis result. The display driver may be configured to transmit the second diagnosis report generated by the processor to a display in the semiconductor device.

The semiconductor device may further include a touch screen controller and a communication module. The touch screen controller may be configured to generate user data corresponding to a user input received through a touch screen of the semiconductor device.

The processor may be configured to generate a first diagnosis report including an identification number of the component based on the second diagnosis report in response to the user data, and to control the communication module to transmit the first diagnosis report to an external communication device.

The component may be configured to control a position of the semiconductor device.

When the component is in an abnormal state, the processor may be configured to generate the control signal for curing the abnormal state of the component according to the diagnosed state.

The semiconductor device may further include a communication module configured to receive a new self-diagnosis policy from an external communication device. The processor may be configured to update the self-diagnosis policy stored in the hardware secure module with the new self-diagnosis policy.

The self-diagnosis policy or the new self-diagnosis policy comprises external environment information regarding the semiconductor device.

According to an exemplary embodiment of the present inventive concept, an Internet of things (IoT) device is provided. The IoT device includes a communication module, a component, a sensor, and a self-diagnosis device. The self-diagnosis device includes a hardware secure module and a processor. The hardware secure module is configured to store a self-diagnosis policy for the component. The processor is configured to receive a detection signal output from the sensor, to diagnose a state of the component using the detection signal and the self-diagnosis policy stored in the hardware secure module, and to generate a first diagnosis report including at least one among an abnormal symptom of the component or an expected replacement time of the component according to the diagnosed state.

The hardware secure module may be configured to store a digital signature of a user of the IoT device. The processor may be configured to generate the first diagnosis report including the digital signature according to the diagnosed state, and to control the communication module to transmit the first diagnosis report including the digital signature to an external communication device.

The self-diagnosis policy may include at least two among a sensing type, a sensing method, a condition, or a cure activity. The processor may be configured to generate a control signal for controlling the state of the component according to the diagnosed state.

When the component is in an abnormal state, the processor may be configured to generate the control signal for curing the abnormal state of the component according to the diagnosed state.

The communication module may be configured to receive a new self-diagnosis policy from an external communication device. The processor may be configured to update the self-diagnosis policy stored in the hardware secure module with the new self-diagnosis policy.

According to an exemplary embodiment of the present inventive concept, a data processing system is provided. The data processing system includes a semiconductor device, a hub, and a server. The semiconductor device includes a processor, a component, a sensor generating a detection signal corresponding to the component, a transceiver, and a memory. The hub includes a diagnosis device generating a first diagnosis report in response to the detection signal. The hub is disposed outside the semiconductor device. The server receives the first diagnosis report from the hub through a network. The processor receives the detection signal output from the sensor, and transmits the detection signal to the hub through the transceiver.

The first diagnosis report may include at least one among an abnormal symptom of the component or an expected replacement time of the component.

The hub may further include a hardware secure module storing a self-diagnosis policy.

The server may generate a new self-diagnosis policy based on the first diagnosis report, and may send the new self-diagnosis policy to the processor.

The processor may update the self-diagnosis policy stored in the hardware secure module with the new self-diagnosis policy.

### BRIEF DESCRIPTION OF THE DRAWINGS

The above and other features of the present inventive concept will become more apparent by describing in detail exemplary embodiments thereof with reference to the attached drawings in which:

FIG. 1 is a block diagram of a device including a self-diagnosis device according to an exemplary embodiment of the present inventive concept;

FIG. 2 is a diagram of profiles included in a self-diagnosis policy illustrated in FIG. 1 according to an exemplary embodiment of the present inventive concept;

FIG. 3 is a diagram of a self-diagnosis engine executed in a processor illustrated in FIG. 1 according to an exemplary embodiment of the present inventive concept;

FIG. 4 is a diagram of a first diagnosis report according to an exemplary embodiment of the present inventive concept;

FIG. 5 is a diagram of a second diagnosis report according to an exemplary embodiment of the present inventive concept;

FIG. 6 is a block diagram of a data processing system including the device illustrated in FIG. 1 according to an exemplary embodiment of the present inventive concept;

FIG. 7 is a block diagram of a data processing system including a device including a self-diagnosis device according to an exemplary embodiment of the present inventive concept;

FIG. 8 is a block diagram of a data processing system including the device illustrated in FIG. 1 or 7 according to an exemplary embodiment of the present inventive concept;

FIG. 9 is a block diagram of a data processing system including the device illustrated in FIG. 1 or 7 according to an exemplary embodiment of the present inventive concept;

FIG. 10 is a block diagram of a data processing system including the device illustrated in FIG. 1 or 7 according to an exemplary embodiment of the present inventive concept;

FIG. 11 is a block diagram of a device for performing a self-diagnosis function according to an exemplary embodiment of the present inventive concept;

FIG. 12 is a block diagram of a device for performing a self-diagnosis function according to an exemplary embodiment of the present inventive concept;

FIG. 13 is a block diagram of a device for performing a self-diagnosis function according to an exemplary embodiment of the present inventive concept;

FIG. 14 is a block diagram of a device for performing a self-diagnosis function according to an exemplary embodiment of the present inventive concept;

FIG. 15 is a block diagram of a device for performing a self-diagnosis function according to an exemplary embodiment of the present inventive concept;

FIG. 16 is a block diagram of an internet of things (IOT) network system for performing a self-diagnosis function according to an exemplary embodiment of the present inventive concept;

FIG. 17 is a block diagram of an IOT network system including the device illustrated in FIG. 1 or 7 according to an exemplary embodiment of the present inventive concept;

FIG. 18 is a block diagram of an IOT network system including the device illustrated in FIG. 1 or 7 according to an exemplary embodiment of the present inventive concept;

FIG. 19 is a block diagram of an IOT network system including the device illustrated in FIG. 1 or 7 according to an exemplary embodiment of the present inventive concept; and

FIG. 20 is a block diagram of an IOT network system including the device illustrated in FIG. 1 or 7 according to an exemplary embodiment of the present inventive concept.

### DETAILED DESCRIPTION OF THE EMBODIMENTS

The present inventive concept now will be described more fully hereinafter with reference to the accompanying drawings, in which exemplary embodiments thereof are shown. The present inventive concept may, however, be embodied in many different forms and should not be construed as limited to the exemplary embodiments thereof set forth herein. In the drawings, the size and relative sizes of layers and regions may be exaggerated for clarity. Like numbers may refer to like elements throughout the specification and drawings. All the elements throughout the specification and drawings may be circuits.

It will be understood that when an element is referred to as being “connected” or “coupled” to another element, it can be directly connected or coupled to the other element or intervening elements may be present.

As used herein, the singular forms “a”, “an” and “the” are intended to include the plural forms as well, unless the context clearly indicates otherwise.

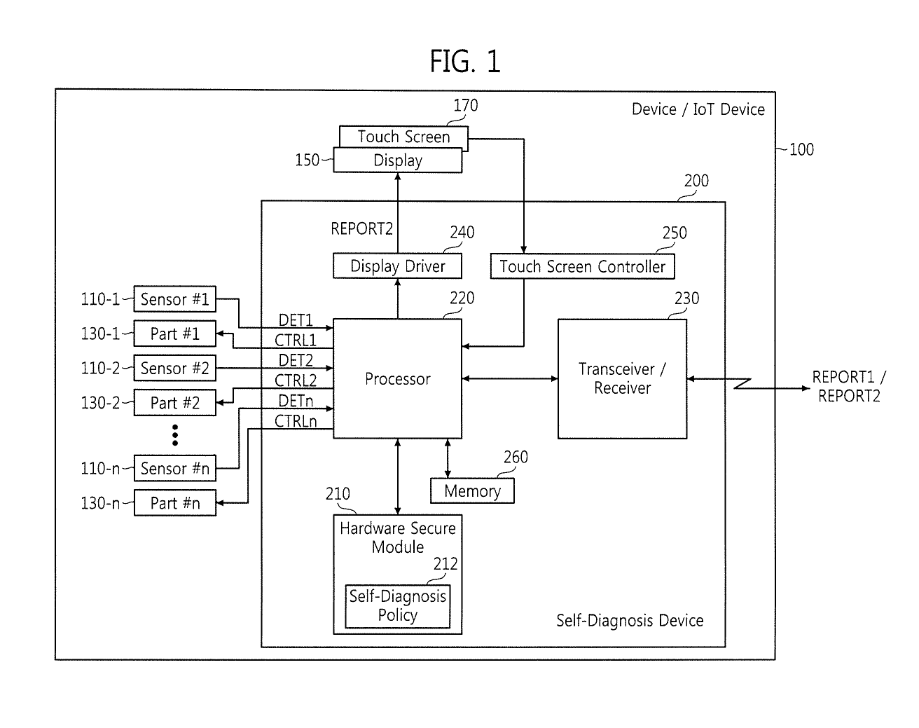

FIG. 1 is a block diagram of a device 100 including a self-diagnosis device 200 according to an exemplary embodiment of the present inventive concept. Referring to FIG. 1, the device 100 (e.g., a semiconductor device) may include a self-diagnosis device 200, a plurality of sensors 110-1 through 110-n, and a plurality of parts 130-1 through 130-n, where “n” is a natural number of at least 3. Although the number of the sensors 110-1 through 110-n is the same as the number of the parts 130-1 through 130-n in an embodiment described with reference to FIG. 1, in the semiconductor device 100, the numbers of sensors may be different from the number of parts formed may be different from each other in an exemplary embodiment of the present inventive concept.

The semiconductor device 100 may include a display 150 and a touch screen 170. As the semiconductor device 100 includes the touch screen 170, the semiconductor device 100 may include a touch screen controller 250. Although the touch screen controller 250 is formed within the self-diagnosis device 200 in an exemplary embodiment described with reference to FIG. 1, the touch screen controller 250 may be formed outside the self-diagnosis device 200 in an exemplary embodiment of the present inventive concept.

The semiconductor device 100 may be implemented as an internet of things (IoT) device. The IoT device, which will be described hereinafter, may include an accessible interface (e.g., a wired interface and/or a wireless interface). The IoT device may refer to a device which can communicate data (e.g., via wired or wireless connection) with at least one electronic device (or another IoT device) using the accessible interface. Here, the accessible interface may include a local area network (LAN), a wireless LAN (WLAN) such as wireless fidelity (Wi-Fi), a wireless personal area network (WPAN) such as Bluetooth, a wireless universal serial bus (USB), ZigBee, near field communication (NFC), radio-frequency identification (RFID), or mobile cellular network, but the present inventive concept is not restricted thereto. The mobile cellular network may include third generation (3G) mobile cellular network, a fourth generation (4G) mobile cellular network, a long term evolution (LTE™) mobile cellular network, LTE-advanced (LTE-A) mobile cellular network, or the like, but the present inventive concept is not restricted thereto.

The self-diagnosis device 200 may receive a detection signal DET1 output from a sensor (e.g., 110-1) corresponding to a part (e.g., 130-1), determine the state of the part 130-1 using the detection signal DET1 and a self-diagnosis policy 212 stored in a hardware secure module 210, and generate a control signal CTRL1 for automatically controlling or curing the state of the part 130-1 based on the determination result.

The self-diagnosis device 200 may be an integrated circuit (IC), a system on chip (SoC), a chip set, or a chip assembly including a plurality of chips. The self-diagnosis device 200 may include the hardware secure module 210, a processor 220, and a transceiver 230. In an exemplary embodiment of the present inventive concept, the self-diagnosis device 200 may further include at least one among a display driver 240, the touch screen controller 250, and a memory 260.

The hardware secure module 210 may be a physical computing device which protects and manages digital keys or the self-diagnosis policy 212, which will be described later, for a strong authentication. The hardware secure module 210 may be embedded in the self-diagnosis device 200, may be formed as a plug-in card, or may be formed as an external unit which can be directly attached to the self-diagnosis device 200. In an exemplary embodiment of the present inventive concept, the hardware secure module 210 may refer to a secure element itself or may include a secure element. The hardware secure module 210 may be a tamper-resistant or tamper-proof platform.

The processor 220 may control elements (or components) included in the self-diagnosis device 200. For example, the processor 220 may execute a detection and cure engine implemented as software or a software component. The detection-and-cure engine may be loaded from the memory 260 to the processor 220 when the semiconductor device 100 is booted and executed in the processor 220. In an exemplary embodiment of the present inventive concept, the detection-and-cure engine may be implemented as hardware or a hardware component within the processor 220.

The processor 220 may receive a detection signal output from a sensor corresponding to a part, may determine the state of the part using the detection signal and the self-diagnosis policy 212 stored in the hardware secure module 210, and may generate a control signal for automatically controlling or curing the state of the part based on the determination result. Here, the state of the part may include a normal state and an abnormal state, for example, a temporal curable malfunctioning state or an incurable malfunctioning state.

For example, the processor 220 may generate a diagnosis report REPORT1 or REPORT2 including at least one among a problem (or an abnormal symptom) of the part and an expected replacement time of the part based on the determination result. The processor 220 may generate the diagnosis report REPORT1 or REPORT2 including a digital signature of a user of the semiconductor device 100.

For example, the processor 220 may be implemented as an IC, a SoC, or an application processor. In an exemplary embodiment of the present inventive concept, the processor 220 may be a single-core processor. In an exemplary embodiment of the present inventive concept, the processor 220 may be a multi-core processor such as dual-core, quad-core, hexa-core or octa-core processor. The processor 220 may further include a cache memory.

The transceiver 230 may use or support accessible interface. For example, the transceiver 230 may include modem communication interface, a modem communication interface circuit, or a modem communication interface chip for communication interface. Accordingly, the transceiver 230 may be connected with an external device using a LAN, a WLAN such as Wi-Fi, a WPAN such as Bluetooth, a wireless USB, ZigBee, NFC, RFID, power line communication (PLC), or the like, or a mobile cellular network. The transceiver 230 may transmit the diagnosis report REPORT1 or REPORT2 generated by the processor 220 to the external device.

The sensors 110-1 through 110-n may include a horizontality sensor, an airflow sensor, a temperature sensor, a humidity sensor, a noise sensor, a friction or vibration sensor, a power consumption sensor, and a cleanness sensor. For example, the horizontality sensor may include a tilt sensor or a gyro sensor. The airflow sensor may include an airflow sensor or a ventilation sensor. The temperature sensor may include a laser temperature sensor or a gas thermometer. The humidity sensor may include a moisture sensor. The noise sensor may include a noise sensor or a sound level sensor. The power consumption sensor may include a power consumption meter. The cleanness sensor may include a dust sensor or an air cleaning sensor. The sensors 110-1 through 110-n described above are only examples. The semiconductor device 100 may include various kinds of sensors according to its purposes.

The parts 130-1 through 130-n may be parts that are necessary for the operations and functions of the semiconductor device 100. The parts 130-1 through 130-n may include a position controller, a motor, an air circulator for controlling an airflow, a temperature controller for controlling the internal temperature of the semiconductor device 100, an humidity controller for controlling the internal humidity of the semiconductor device 100, a state estimator for estimating the state of each of the parts 130-1 through 130-n, an air cleaner, or a dehumidifier, but the present inventive concept is not restricted thereto. Here, parts may refer to components, which may include a mechanical component, an electronic component, and/or a software component.

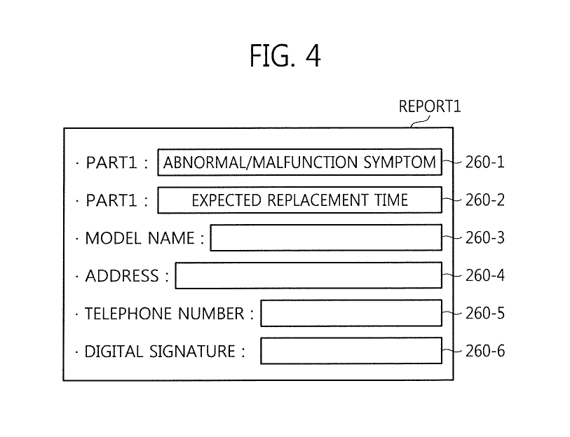

FIG. 4 is a diagram of a first diagnosis report REPORT1 according to an exemplary embodiment of the present inventive concept. Referring to FIGS. 1 and 4, when the second sensor 110-2 is a vibration sensor, the first part 130-1 is a motor, and the second part 130-2 is a tilt controller for controlling the tilt of the motor 130-1, the vibration sensor 110-2 detects the vibration of the motor 130-1 and transmits a vibration detection signal DET2 corresponding to the detection vibration of the motor 130-1 to the processor 220.

The processor 220 compares the vibration detection signal DET2 with a reference vibration signal corresponding to a reference vibration value included in the self-diagnosis policy 212 stored in the hardware secure module 210, generates a second control signal CTRL2 when the vibration detection signal DET2 is greater than the reference vibration signal (e.g., the motor 130-1 operates in an abnormal state), and outputs the second control signal CTRL2 to the tilt controller 130-2. The tilt controller 130-2 adjusts the tilt of the motor 130-1 in response to the second control signal CTRL2.

The vibration sensor 110-2 detects the vibration of the motor 130-1 whose tilt has been controlled and transmits the vibration detection signal DET2 corresponding to the detection result to the processor 220. The processor 220 compares the vibration detection signal DET2 with the reference vibration signal corresponding to the reference vibration value included in the self-diagnosis policy 212 stored in the hardware secure module 210, generates the second control signal CTRL2 when the vibration detection signal DET2 is greater than the reference vibration signal (e.g., the motor 130-1 still operates in the abnormal state), and outputs the second control signal CTRL2 to the tilt controller 130-2. The tilt controller 130-2 re-adjusts the tilt of the motor 130-1 in response to the second control signal CTRL2.

When the motor 130-1 still operates in the abnormal state even after the tilt of the motor 130-1 has been adjusted a predetermined number of times, the processor 220 generates the first diagnosis report REPORT1 based on the vibration detection signal DET2 and the reference vibration signal, and sends the first diagnosis report REPORT1 to the transceiver 230. The transceiver 230 may transmit the first diagnosis report REPORT1 to an external communication device (e.g., a wireless communication device).

As shown in FIG. 4, the first diagnosis report REPORT1 may include an abnormal/malfunction symptom 260-1 of the motor 130-1, an expected replacement time 260-2 of the motor 130-1, and a model name 260-3. The model name 260-3 is a serial (or unique) number of the part.

In an exemplary embodiment of the present inventive concept, the first diagnosis report REPORT1 may further include at least one among an address 260-4 of a user of the semiconductor device 100, a telephone number 260-5 of the user, and a digital signature 260-6 of the user. For example, the address 260-4, the telephone number 260-5, and the digital signature 260-6 may be used as information for after-sales service (AS) to the semiconductor device 100.

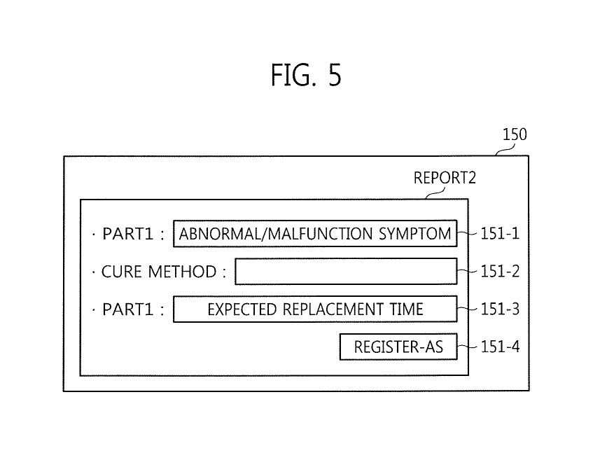

FIG. 5 is a diagram of the second diagnosis report REPORT2 according to an exemplary embodiment of the present inventive concept. Referring to FIGS. 1 and 5, when the motor 130-1 still operates in the abnormal state even after the tilt of the motor 130-1 has been adjusted a predetermined number of times, the processor 220 may generate the second diagnosis report REPORT2 based on the vibration detection signal DET2 and the reference vibration signal, and may send the second diagnosis report REPORT2 to the display driver 240. The display driver 240 may display the second diagnosis report REPORT2 using the display 150.

The display 150 may display an abnormal/malfunction symptom 151-1 of the motor 130-1, a cure 151-2, an expected replacement time 151-3 of the motor 130-1, and a register-AS 151-4, as shown in FIG. 5. When a user touches the register-AS 151-4 through the touch screen 170, the touch screen 170 transmits a user input corresponding to the touch on the touch screen 170 to the touch screen controller 250. The touch screen controller 250 may transmit user data corresponding to the user input to the processor 220.

The processor 220 generates the first diagnosis report REPORT1 based on the vibration detection signal DET2 and the reference vibration signal in response to the user data, and sends the first diagnosis report REPORT1 to the transceiver 230. The transceiver 230 may transmit the first diagnosis report REPORT1 to an external communication device (e.g., a wireless communication device). For example, the external wireless communication device may be a user's smart phone.

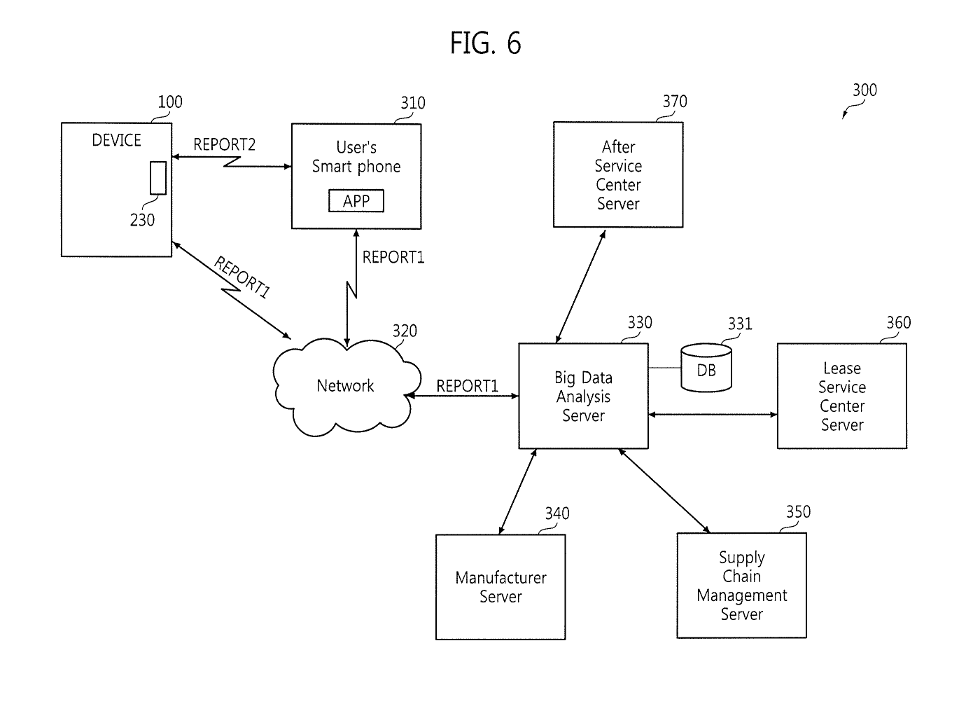

In an exemplary embodiment of the present inventive concept, the processor 220 may directly send the second diagnosis report REPORT2 to the external wireless communication device via the transceiver 230. An application (e.g., APP) executed in the external wireless communication device (e.g., 310 in FIG. 6) may display the second diagnosis report REPORT2 through a display of the external wireless communication device. When the user touches the register-AS 151-4 in the second diagnosis report REPORT2, the application may generate and send the first diagnosis report REPORT1 to an external wireless communication device.

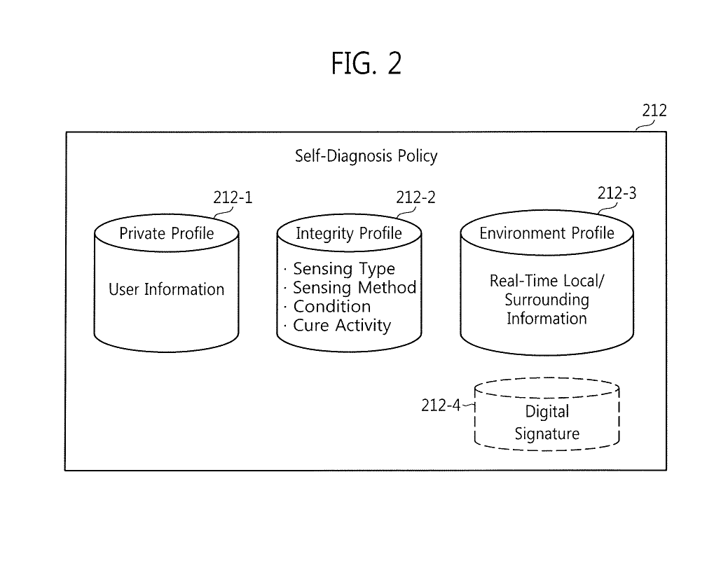

FIG. 2 is a diagram of profiles included in the self-diagnosis policy 212 illustrated in FIG. 1 according to an exemplary embodiment of the present inventive concept. Referring to FIGS. 1 and 2, the self-diagnosis policy 212 may include a first profile 212-1, a second profile 212-2, and a third profile 212-3. The self-diagnosis policy 212 may further include a digital signature 212-4. For example, the self-diagnosis policy 212 may be stored in secure memory, which may be formed of non-volatile memory. For example, the self-diagnosis policy 212 may be decoded data.

The first profile, e.g., private profile 212-1, may refer to user information. For example, the user information may include a user experience (UX)-based activity pattern (e.g., a use pattern of a user of the semiconductor device 100), a model name of the semiconductor device 100, an address of the user of the semiconductor device 100, and the user's telephone number, or the like, but the present inventive concept is not restricted thereto.

The second profile, e.g., integrity profile 212-2, may include a sensing type (e.g., an object of sensing), a sensing method, a condition, and cure activity, but the present inventive concept is not restricted thereto. For example, the integrity profile 212-2 may store information about which object is sensed using which sensor and how the object is cured.

For example, horizontality, which corresponds to the sensing type, of the semiconductor device 100 is sensed using a horizontality sensor, which corresponds to the sensing method, and vibration, which corresponds to the sensing type, of a part of the semiconductor device 100 is sensed using a vibration sensor, which corresponds to the sensing method. Unless the tilt (e.g., an angle between the front and the back) of the semiconductor device 100 is 10 to 15 degrees, which corresponds to the condition of the semiconductor device 100, the efficiency and durability of the semiconductor device 100 may decrease. Accordingly, the tilt of the semiconductor device 100 needs to be maintained at 10 to 15 degrees, which corresponds to the cure activity, and therefore, a part (e.g., a tilt controlling device) controlled by the processor 220 may adjust the tilt of the semiconductor device 100.

The third profile (e.g., environment profile 212-3) may include weather around the semiconductor device 100 or real-time local information and/or surrounding information regarding at least one device which can communicate with the semiconductor device 100, but the present inventive concept is not restricted thereto.

The transceiver 230 may transmit a new self-diagnosis policy received from an external communication device to the processor 220. The processor 220 may update the self-diagnosis policy 212 stored in the hardware secure module 210 with the new self-diagnosis policy.

The digital signature 212-4 may be used to authenticate the first diagnosis report REPORT1 or the second diagnosis report REPORT2.

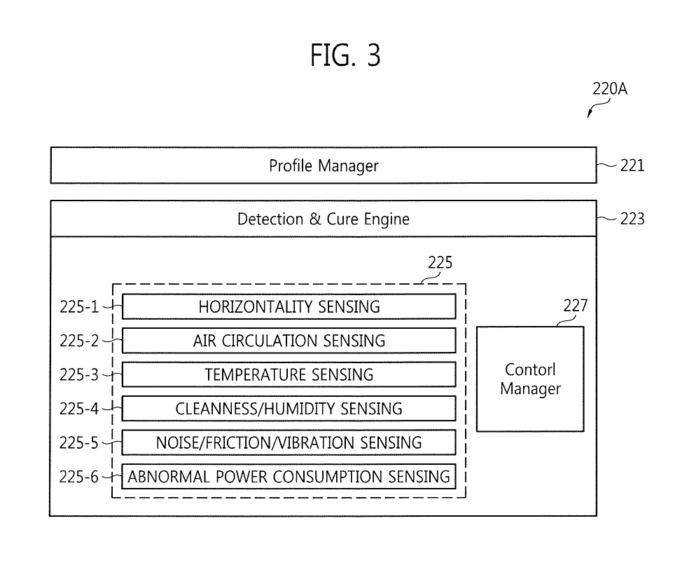

FIG. 3 is a diagram of a self-diagnosis engine 220A executed in the processor 220 illustrated in FIG. 1 according to an exemplary embodiment of the present inventive concept. Referring to FIGS. 1 through 3, the self-diagnosis engine 220A executed in the processor 220 may include a profile manager 221 and a detection-and-cure engine 223. Although the components 221 and 223 are implemented as software in an embodiment described with reference to FIG. 3, the components 221 and 223 may be implemented as hardware in an exemplary embodiment of the present inventive concept.

The profile manager 221 may manage the self-diagnosis policy 212. For example, the profile manager 221 may perform an operation of writing the self-diagnosis policy 212 to a memory area of the hardware secure module 210 and an operation of reading the self-diagnosis policy 212 from the memory area.

The detection and cure engine 223 may select a sensing type 225 based on the second profile 212-2 of the self-diagnosis policy 212. A control manager 227 of the detection and cure engine 223 may perform a cure activity based on the second profile 212-2 of the self-diagnosis policy 212. The sensing type 225 may include horizontality sensing 225-1, air circulation sensing 225-2, temperature sensing 225-3, cleanness/humidity sensing 225-4, noise/friction/vibration sensing 225-5, and abnormal power consumption sensing 225-6.

A sensing method for the horizontality sensing 225-1 may be performed by a horizontality sensor. A sensing method for the air circulation sensing 225-2 may be performed by an airflow sensor. A sensing method for the temperature sensing 225-3 may be performed by a temperature sensor. A sensing method for the cleanness/humidity sensing 225-4 may be performed by a cleanness sensor and/or a humidity sensor. A sensing method for the noise/friction/vibration sensing 225-5 may be performed by a noise sensor, a friction sensor, and/or a vibration sensor. A sensing method for the abnormal power consumption sensing 225-6 may be performed by a power consumption sensor.

The control manager 227 may generate at least one control signal for a cure activity based on at least one among the first through third profiles 212-1 through 212-3 and a detection signal output from at least one sensor corresponding to the selected sensing type 225. Accordingly, at least one part (or component) may perform a cure operation (or a cure activity) on itself in response to the at least one control signal.

FIG. 6 is a block diagram of a data processing system 300 including the device 100 illustrated in FIG. 1 according to an exemplary embodiment of the present inventive concept. Referring to FIGS. 1 through 6, the data processing system 300 may include a semiconductor device 100, a user's smart phone 310, a network 320, and a big data analysis server 330 which can access a database (DB) 331. In an exemplary embodiment of the present inventive concept, the data processing system 300 may further include at least one among a manufacturer server 340, a supply chain management (SCM) server 350, a lease service center server 360, and an AS center server 370.

In an exemplary embodiment of the present inventive concept, when the semiconductor device 100 transmits the first diagnosis report REPORT1 to the network 320 through the transceiver 230, the first diagnosis report REPORT1 may be transmitted to the big data analysis server 330 via the network 320. In an exemplary embodiment of the present inventive concept, when the semiconductor device 100 transmits the second diagnosis report REPORT2 to the user's smart phone 310 through the transceiver 230, an application APP in the user's smart phone 310 may generate the first diagnosis report REPORT1 based on the second diagnosis report REPORT2 and may transmit the first diagnosis report REPORT1 to the network 320. The first diagnosis report REPORT1 may be transmitted to the big data analysis server 330 via the network 320.

Referring back to FIG. 4, the first diagnosis report REPORT1 may include the abnormal/malfunction symptom 260-1 of a first part subjected to diagnosis and the expected replacement time 260-2 of the first part. In an exemplary embodiment of the present inventive concept, the first diagnosis report REPORT1 may further include at least one among the model name 260-3 of the semiconductor device 100 or the first part, an address 260-4 of a user of the semiconductor device 100, the telephone number 260-5 of the user, and the digital signature 260-6.

The big data analysis server 330 may analyze the abnormal/malfunction symptom 260-1 and the expected replacement time 260-2 of the first part according to the content of the first diagnosis report REPORT1, and may store the analysis result in the DB 331. For example, the big data analysis server 330 may provide the analysis result to at least one among the manufacturer server 340, the SCM server 350, the lease service center server 360, and the AS center server 370. For example, the manufacturer server 340 may perform management on the device 100 or the part (e.g., the first part) according to the analysis result.

The SCM server 350 may perform management on the part (e.g., the first part) based on the analysis result or the first diagnosis report REPORT1 provided from the big data analysis server 330. The lease service center server 360 may inform the user's smart phone 310 of whether the semiconductor device 100 or the part (e.g., the first part) has been leased or not based on the analysis result or the first diagnosis report REPORT1 provided from the big data analysis server 330.

The AS center server 370 may provide AS to the user of the semiconductor device 100 based on the analysis result or the first diagnosis report REPORT1 provided from the big data analysis server 330.

The big data analysis server 330 may generate a new self-diagnosis policy based on the content of the first diagnosis report REPORT1 or the analysis result, and send the new self-diagnosis policy to the semiconductor device 100 via the network 320. The processor 220 of the semiconductor device 100 may receive the new self-diagnosis policy through the transceiver 230, and may update the self-diagnosis policy 212 stored in the hardware secure module 210 with the new self-diagnosis policy.

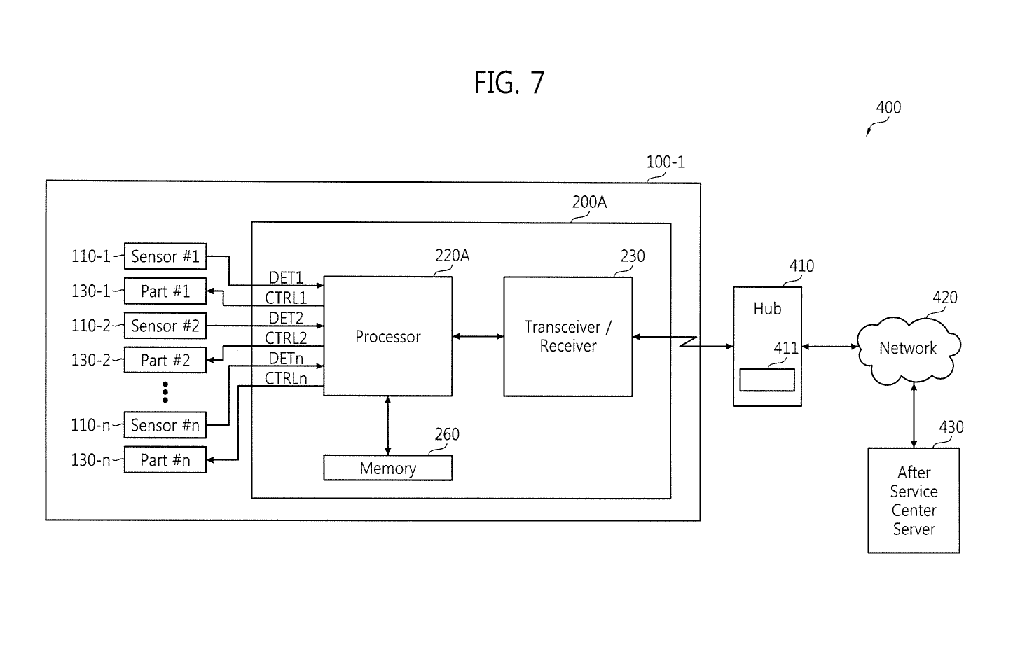

FIG. 7 is a block diagram of a data processing system 400 including a device including a self-diagnosis device according to an exemplary embodiment of the present inventive concept. Referring to FIG. 7, the semiconductor device 100-1 may include a processing device 200A, a plurality of the sensors 110-1 through 110-n, and plurality of the parts 130-1 through 130-n. The processing device 200A may include a processor 220A, the transceiver 230, and the memory 260. The processing device 200A illustrated in FIG. 7 neither diagnoses nor cures the state of the parts 130-1 through 130-n based on detection signals DET1 through DETn output from the respective sensors 110-1 through 110-n.

The processor 220A may receive a signal corresponding to each of the detection signals DET1 through DETn respectively output from the sensors 110-1 through 110-n and transmit the signal to a hub 410 through the transceiver 230. The hub 410 may include the hardware secure module 210 and a diagnosis device 411 which performs a self-diagnosis function. The hardware secure module 210 may store the self-diagnosis policy 212. For example, the diagnosis device 411 may generate the first diagnosis report REPORT1 in response to a detection signal output from the semiconductor device 100-1, and may send the first diagnosis report REPORT1 to an AS center server 430 via a network 420. For example, the AS center server 430 may perform operations the same as or similar to those performed by the big data analysis server 330 illustrated in FIG. 6.

For example, the AS center server 430 may analyze the abnormal/malfunction symptom 260-1 and the expected replacement time 260-2 of the first part according to the content of the first diagnosis report REPORT1. The AS center server 430 may generate a new self-diagnosis policy based on the content of the first diagnosis report REPORT1 or the analysis result, and send the new self-diagnosis policy to the hub 410 via the network 420. The processor 220A of the semiconductor device 100-1 may update the self-diagnosis policy 212 stored in the hardware secure module 210 with the new self-diagnosis policy.

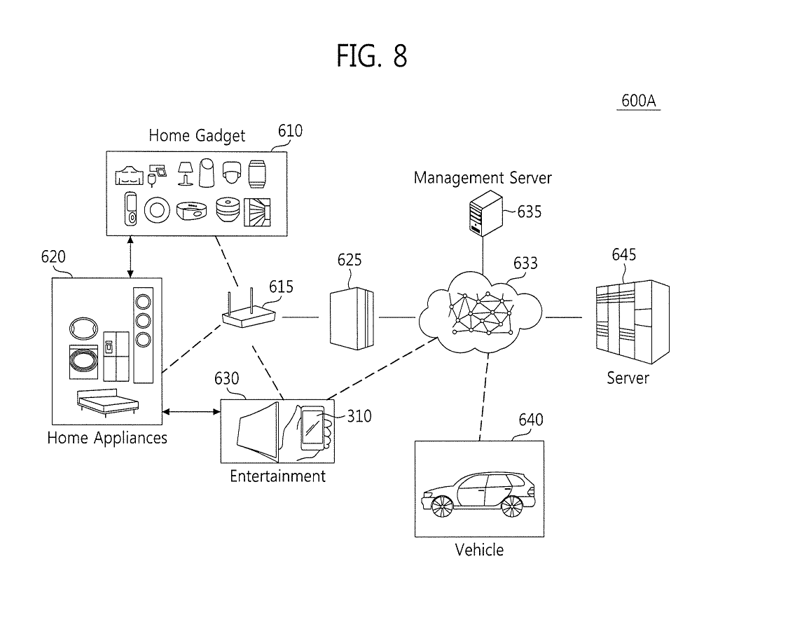

FIG. 8 is a block diagram of a data processing system 600A including the device 100 of FIG. 1 or 100-1 of FIG. 7 according to an exemplary embodiment of the present inventive concept. Referring to FIGS. 1 through 8, the data processing system 600A may include a hub 615 and IoT devices 610, 620, 630, and 640. For example, the structure and operations of the IoT devices 610, 620, 630, and 640 may be the same as or similar to those of the semiconductor device 100 of FIG. 1 or the semiconductor device 100-1 of FIG. 7. For example, each of the IoT devices 610, 620, 630, and 640 may generate and send the first or second diagnosis report REPORT1 or REPORT2 to the user's smart phone 310 or the hub 615.

An IoT or the data processing system 600A may refer to a network among IoT devices that use wired and/or wireless communication. Accordingly, an IoT here may be referred to as an IoT network system, a ubiquitous sensor network (USN) communication system, a machine type communication (MTC) system, a machine-oriented communication (MOC) system, a machine-to-machine (M2M) communication system, a device-to-device (D2D) communication system, or the like.

Here, an IoT network system may include elements, such as an IoT device, a hub, an access point, a gateway, a communication network, a server, or the like. However, these elements are defined only for description purpose of the IoT network system, and thus, the scope of the IoT network system is not restricted to these elements.

The IoT network system may use a user datagram protocol (UDP), a transmission protocol such as a transmission control protocol (TCP), an IPv6 low-power wireless personal area networks (6LoWPAN) protocol, an IPv6 internet routing protocol, a constrained application protocol (CoAP), a hypertext transfer protocol (HTTP), a message queue telemetry transport (MQTT), an MQTT for sensors networks (MQTT-S) for exchange (or communication) of information among at least two elements therewithin, or the like.

When the IoT network system is implemented as a wireless sensor network (WSN), each of the IoT devices 610, 620, 630, and 640 may be used as a sink node or a sensor node. The sink node is also called a base station, and the sink node plays as a gateway connecting the WSN with an external network (e.g., an internet). The sink node may assign a task to the sensor node and gather events sensed by the sensor node. The sensor node is a node within the WSN, and the sensor node may process and gather sensory information. The sensor node may communicate with other nodes (e.g., sensor nodes) in the WSN.

The IoT devices 610, 620, 630, and 640 may include an active IoT device which operates using its own power and a passive IoT device which operates using wireless power transferred from an external power source. For example, the active IoT device may include a refrigerator, an air conditioner, a telephone, an automobile, or the like. The passive IoT device may include an RFID tag, an NFC tag, or the like. However, when an RFID tag or an NFC tag includes a battery, the RFID or NFC tag may be an active IoT device.

In an exemplary embodiment of the present inventive concept, the IoT devices 610, 620, 630, and 640 may include a passive communication interface such as a two-dimensional (2-D) barcode, a three-dimensional (3-D) barcode, a QR code, an RFID tag, an NFC tag, or the like. The IoT devices 610, 620, 630, and 640 may further include an active communication interface such as a modem a transceiver, or the like.

Each of the IoT devices 610, 620, 630, and 640 may gather data using at least one among the sensors 110-1 through 110-n described with reference to FIG. 1 and transmit the gathered data to an external device or an external IoT device through a wired or wireless communication interface. At least one of the IoT devices 610, 620, 630, and 640 may transmit and receive control information and/or data through a wired or wireless communication interface. The wired or wireless communication interface may be an example of an accessible interface.

The hub 615 in the IoT network system 600A may function as an access point. Each of the IoT devices 610, 620, 630, and 640 may be connected to a communication network or other IoT devices through the hub 615.

Although the hub 615 is shown as an independent device in FIG. 8, the hub 615 may be embedded in one of the IoT devices 610, 620, 630, and 640. For example, the hub 615 may be embedded in a television (TV or a smart TV), a smart refrigerator, or the like. At this time, a user may monitor or control at least one of the IoT devices 610, 620, 630, and 640 connected to the hub 615 through a display of the TV or the smart refrigerator. In an exemplary embodiment of the present inventive concept, the hub 615 may be one of the IoT devices 610, 620, 630, and 640. For example, a smart phone may be an IoT device functioning as the hub 615. For example, the smart phone may perform tethering.

The IoT network system 600A may further include a gateway 625. The gateway 625 may connect the hub 615, which functions as an access point, to an external communication network (e.g., an internet or a public switched network). Each of the IoT devices 610, 620, 630, and 640 may be connected to an external communication network through the gateway 625. In an exemplary embodiment of the present inventive concept, the hub 615 and the gateway 625 may be implemented in a single device. In an exemplary embodiment of the present inventive concept, the hub 615 may function as a first gateway and the gateway 625 may function as a second gateway.

One of the IoT devices 610, 620, 630, and 640 may function as the gateway 625. For example, a smart phone may be both an IoT device and the gateway 625. The smart phone may be connected to a mobile cellular network.

The IoT network system 600A may further include at least one communication network 633. The communication network 633 may include an internet and/or a public switched network, but the present inventive concept is not restricted thereto. The public switched network may include a mobile cellular network. The communication network 633 may be a communication channel which transfers information gathered by the IoT devices 610, 620, 630, and 640.

The IoT network system 600A may further include a management server 635 and/or a server 645 connected to the communication network 630. The communication network 633 may transmit a signal (or data) detected by at least one of the IoT devices 610, 620, 630, and 640 to the management server 635 and/or the server 645.

The management server 635 and/or the server 645 may store or analyze a signal received from the communication network 633. The management server 635 and/or the server 645 may perform operations the same as or similar to those performed by the big data analysis server 330 illustrated in FIG. 6.

The management server 635 and/or the server 645 may transmit the analysis result to at least one of the IoT devices 610, 620, 630, and 640 via the communication network 633. For example, the management server 635 may manage the states of the hub 615, the gateway 625, the communication network 633, and/or the IoT devices 610, 620, 630, and 640.

The server 645 may receive and store data related to at least one of the IoT devices 610, 620, 630, and 640, and may analyze the stored data. The server 645 may transmit the analysis result to at least one of the IoT devices 610, 620, 630, and 640 or to a device (e.g., a smart phone) possessed by a user via the communication network 633.

For example, when one of the IoT devices 610, 620, 630, and 640 is a blood glucose monitoring IoT device which measures a user's blood glucose, the server 645, which stores a blood glucose limit level preset by the user, may receive a measured blood glucose level from the blood glucose monitoring IoT device via the communication network 633. The server 645 may compare the blood glucose limit level with the measured blood glucose level, and may transmit a warning signal to at least one of the IoT devices 610, 620, 630, and 640 or a user device via the communication network 633 when the measured blood glucose level is higher than the blood glucose limit level.

The IoT devices 610, 620, 630, and 640 illustrated in FIG. 8 may be classified into groups according to their characteristics. For example, some of the IoT devices 610, 620, 630, and 640 may be classified into at least one of the home gadget group 610, the home appliances/furniture group 620, the entertainment group 630, and the vehicle group 640.

For example, the home gadget group 610 may include a heart rate sensor patch, a medical tool for measuring blood glucose level, a lighting equipment, a hygrometer, a surveillance camera, a smart watch, a security keypad, a temperature controller, an aroma diffuser, a window blind, or the like. However, the present inventive concept is not restricted to these examples.

The home appliances/furniture group 620 may include a robot vacuum cleaner, a washing machine, a refrigerator, an air conditioner, a TV, a furniture (e.g., a bed including a sensor), or the like, but the present inventive concept is not restricted to these examples. The entertainment group 630 may include a TV, a smart TV, the smart phone 310, a multimedia video system, or the like, but the present inventive concept is not restricted to these examples.

Some of the IoT devices 610, 620, 630, and 640 may further be included into a temperature control group which controls indoor temperature, a large appliances group and a small appliances group according to power consumption, a cleanness group which controls indoor cleanness (e.g., air purifying and floor cleaning), a lighting group which controls indoor lights, an entertainment group which controls entertainment equipment (such as TV and audio systems), or the like. For example the temperature control group may include an air conditioner, a power window, an electric curtain, or the like.

Each of the IoT devices 610, 620, 630, and 640 may belong to at least one group. For example, an air conditioner may belong to both the home appliances/furniture group 620 and the temperature control group. A TV may belong to both the home appliances/furniture group 620 and the entertainment group 630. The smart phone 310 may belong to both the home gadget group 610 and the entertainment group 630.

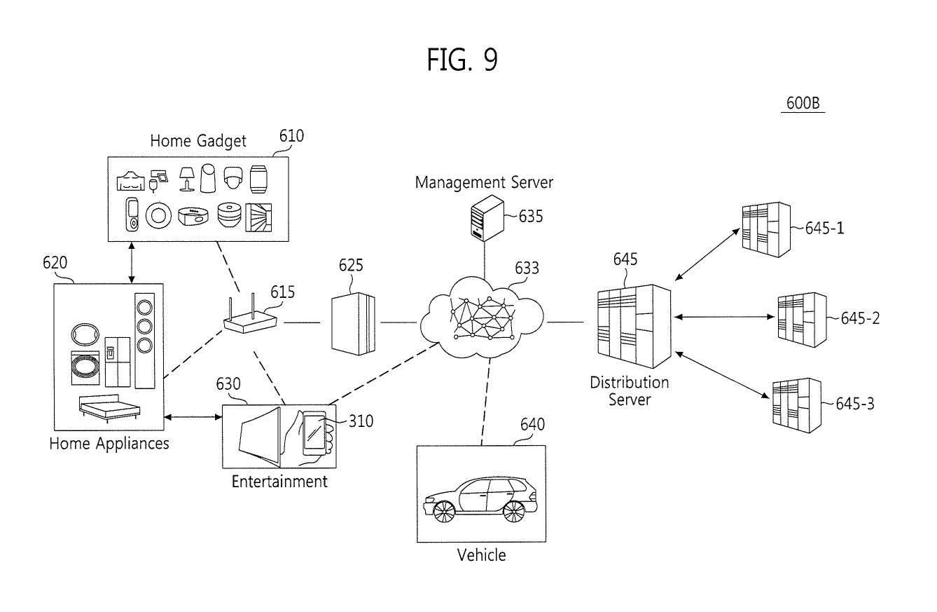

FIG. 9 is a block diagram of a data processing system 600B including the device 100 of FIG. 1 or 100-1 of FIG. 7 according to an exemplary embodiment of the present inventive concept. Referring to FIGS. 1 through 9, the IoT network system 600B may include the hub 615, the smart phone 310, the IoT devices 610, 620, 630, and 640, the gateway 625, the communication network 633, the management server 635, a distribution server 645, and a plurality of servers 645-1, 645-2, and 645-3. Except that the data processing system 600B includes the plurality of servers 645-1, 645-2, and 645-3, the IoT network system 600B of FIG. 9 is the same as or similar to the IoT network system 600A of FIG. 8.

The distribution server 645 is connected with the servers 645-1, 645-2, and 645-3 and may distribute jobs to the servers 645-1, 645-2, and 645-3. The distribution server 645 may analyze a request transmitted from the communication network 633 through scheduling, may predict an amount of data and workload related to a job based on the analysis result, and may communicate with at least one of the servers 645-1, 645-2, and 645-3. At this time, the distribution server 645 may receive and analyze state information from the servers 645-1, 645-2, and 645-3, and may reflect the analysis result to the scheduling. The overall performance of the IoT network system 600B can be enhanced through the scheduling of the distribution server 645.

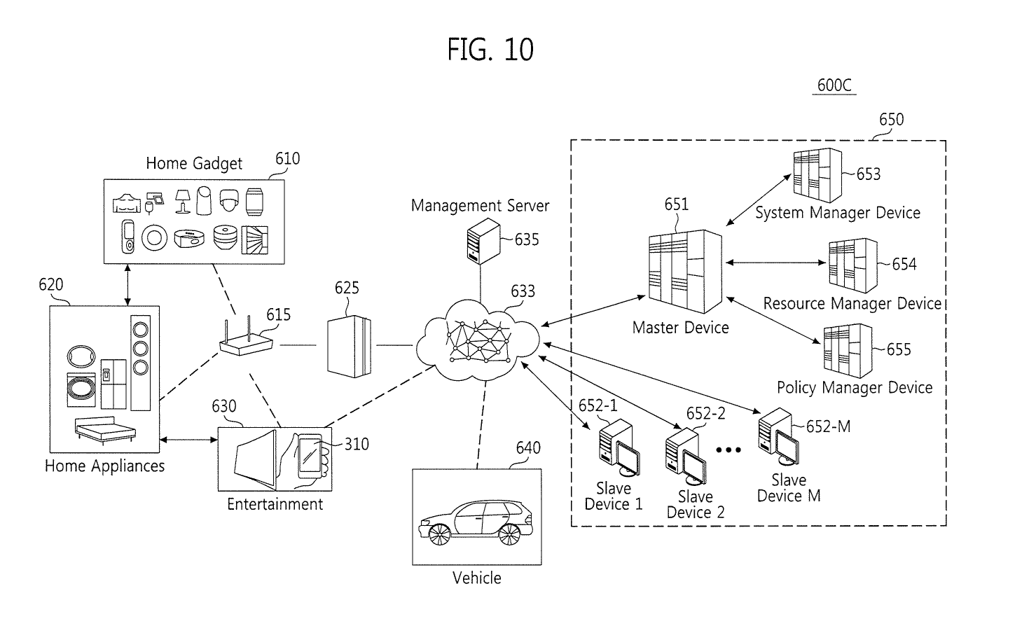

FIG. 10 is a block diagram of a data processing system 600C including the device 100 of FIG. 1 or 100-1 of FIG. 7 according to an exemplary embodiment of the present inventive concept. Referring to FIGS. 1 through 10, the IoT network system 600C may include the hub 615, the smart phone 310, the IoT devices 610, 620, 630, and 640, the gateway 625, the communication network 633, the management server 635, and a distribution server system 650.

The distribution server system 650 may receive and store or analyze data from the communication network 633. The distribution server system 650 may send the stored data or the analyzed data to at least one of the elements 615, 625, 610, 620, 630, 625, and 640 included in the IoT network system 600C via the communication network 633.

In an exemplary embodiment of the present inventive concept, the distribution server system 650 may include a distributed computing system driven based on a distributed file system (DFS). For example, the distribution server system 650 may be driven based on at least one among various DFSs such as Hadoop DFS (HDFS), Google file system (GFS), Cloud store, Coda, NFS, and general parallel file system (GPFS), but the present inventive concept is not restricted to these examples.

In an exemplary embodiment of the present inventive concept, the distribution server system 650 may include a master device 651, slave devices 652-1 through 652-N (where N is a natural number of at least 3), a system manager device 653, a resource manager device 654, and a policy manager device 655. For example, the master device 651 may perform operations the same as or similar to those performed by the big data analysis server 330 illustrated in FIG. 6.

Each of the slave devices 652-1 through 652-N may store a data block. For example, data transmitted via the communication network 633 may be divided into a plurality of data blocks by the master device 651. The data blocks may be stored in the slave devices 652-1 through 652-N in a distributed fashion. For example, when the distribution server system 650 is driven based on the HDFS, each of the slave devices 652-1 through 652-N may execute, as a data node, a task tracker to store at least one data block.

The master device 651 may divide data transmitted via the communication network 633 into a plurality of data blocks. The master device 651 may provide each of the data blocks to at least one of the slave devices 652-1 through 652-N. For example, when the distribution server system 650 is driven based on the HDFS, the master device 651 may execute, as a name node, a job tracker to schedule the distribution of the data blocks. The master device 651 may manage distributed storage information indicating a stored position of each of the data distributed blocks. The master device 651 may process a data write request and a data read request based on the distributed storage information.

The system manager device 653 may control and manage the overall operation of the distribution server system 650. The resource manager device 654 may manage the resource usage of each of elements included in the distribution server system 650. The policy manager device 655 may manage a policy on an access to each of the IoT devices 610, 620, 630, and 640 which are accessible via the communication network 633.

The master device 651, the slave devices 652-1 through 652-N, the system manager device 653, the resource manager device 654, and the policy manager device 655 each may include a universal computer such as a personal computer (PC) and/or a dedicated computer such as a workstation, and each may include hardware modules for realizing a unique function. Further, the master device 651, the slave devices 652-1 through 652-N, the system manager device 653, the resource manager device 654, and the policy manager device 655 each may perform a unique function by running software or firmware using a processor core.

As shown in FIG. 10, the master device 651 and the slave devices 652-1 through 652-N may share the communication network 633 with the IoT devices 610, 620, 630, and 640, and may communicate data (e.g., a data block) with one another via the communication network 633.

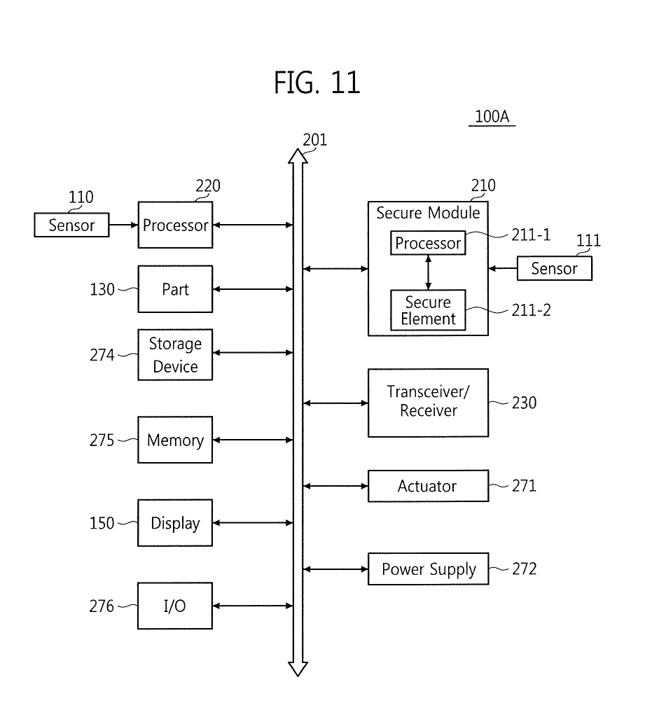

FIG. 11 is a block diagram of a device 100A for performing a self-diagnosis function according to an exemplary embodiment of the present inventive concept. Referring to FIGS. 1 and 11, the semiconductor device 100A may include a bus 201, at least one sensor 110, at least one sensor 111, at least one part 130, a display 150, a hardware secure module 210, a processor 220, a transceiver 230, an actuator 271, a power supply 272, a storage device 274, a memory 275, and an input/output (I/O) device 276. The elements 130, 150, 210, 220, 230, 271, 272, 274, 275, and 276 may communicate a command and/or data with one another via the bus 201.

The sensor 110 may collectively refer to the sensors 110-1 through 110-n illustrated in FIG. 1. The part 130 may collectively refer to the parts 130-1 through 130-n illustrated in FIG. 1. The display 150 may display data processed by the semiconductor device 100A or may provide a user interface (UI) or a graphical user interface (GUI) to a user.

The processor 220 may control the overall operation of the semiconductor device 100A. The processor 220 may execute an application providing an internet browser, a game, a moving image, or the like. The transceiver 230 may perform communication as a communication interface using LAN, WLAN (e.g., Wi-Fi), WPAN (e.g., Bluetooth), wireless USB, ZigBee, NFC, RFID, PLC, mobile cellular network, or the like.

The storage device 274 may store a boot image for booting the semiconductor device 100A. For example, the storage device 274 may be implemented as a hard disk drive (HDD), a solid state drive (SSD), a multimedia card (MMC), an embedded MMC (eMMC), a universal flash storage (UFS), or the like. The memory 275 may store data necessary for the operation of the semiconductor device 100A. For example, the memory 275 may include volatile memory and/or non-volatile memory. The I/O device 276 may include an input unit such as a touch pad, a keypad, an input button, or the like, and an output unit such as a speaker.

The sensor 110 may transmit a detection signal to the processor 220. The sensor 111 may be a bio sensor which detects biometric information. For example, the sensor 111 may detect a fingerprint, an iris pattern, a vein pattern, a heart rate, a blood glucose level, may generate detection data corresponding to the detection result, and may provide the detection data to a processor 211-1 of the hardware secure module 210. However, the sensor 111 is not restricted to the biosensor, and for example, may be a luminance sensor, an acoustic sensor, an acceleration sensor, or the like.

The hardware secure module 210 may include the processor 211-1 and a secure element 211-2. The hardware secure module 210 may be formed in a single package and a bus connecting the processor 211-1 and the secure element 211-2 may be formed within the package. The secure element 211-2 may have a function of defending against external attacks and thus, the secure element 211-2 may be used to safely store secure data. The processor 211-1 may communicate data with the processor 220.

The hardware secure module 210 may include the secure element 211-2. The hardware secure module 210 and the processor 220 may generate a session key through mutual authentication. The hardware secure module 210 may encrypt data using the session key and transmit the encrypted data to the processor 220. The processor 220 may decrypt the encrypted data using the session key and may generate decrypted detection data. Accordingly, the security level of data transmission in the semiconductor device 100A is increased. For example, the secure element 211-2 may be formed in a single package together with the processor 220.

The processor 211-1 of the hardware secure module 210 may encrypt detection data output from the sensor 111 and may store the encrypted data in the secure element 211-2. The processor 211-1 may control communication between the processor 220 and the secure element 211-2.

The actuator 271 may include various elements necessary for the physical driving of the semiconductor device 100A. For example, the actuator 271 may include a motor driving circuit and a motor controlled by the motor driving circuit. The power supply 272 may provide an operating voltage necessary for the operation of the semiconductor device 100A. The power supply 272 may include a battery.

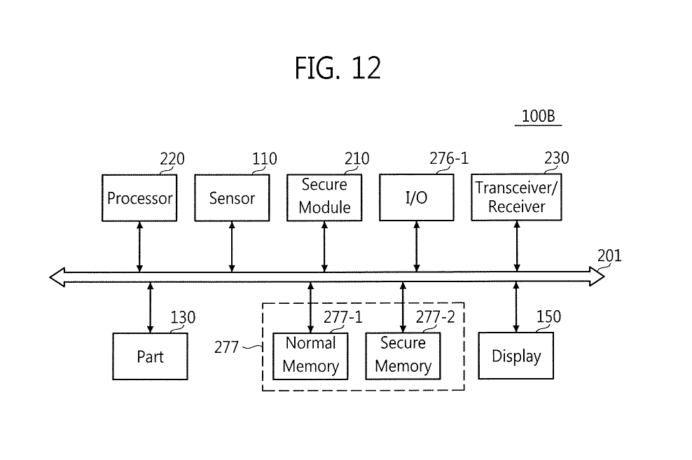

FIG. 12 is a block diagram of a device 100B for performing a self-diagnosis function according to an exemplary embodiment of the present inventive concept. Referring to FIGS. 1 and 12, the semiconductor device 100B may include the sensor 110, the part 130, the display 150, the bus 201, the hardware secure module 210, the processor 220, the transceiver 230, an I/O device 276-1, and a memory 277. The memory 277 may include a normal memory 277-1 and a secure memory 277-2. The elements 110, 130, 150, 210, 220, 230, 276-1, and 277 may communicate data with one another via the bus 201.

The sensor 110 may collectively refer to the sensors 110-1 through 110-n illustrated in FIG. 1. The part 130 may collectively refer to the parts 130-1 through 130-n illustrated in FIG. 1. The display 150 may display data processed by the semiconductor device 100B or provide a UI or a GUI to a user. The processor 220 may control the overall operation of the semiconductor device 100B.

The normal memory 277-1 may store data necessary for the operation of the semiconductor device 100B. The normal memory 277-1 may be formed of volatile memory or non-volatile memory which stores data that does not require security. The secure memory 277-2 may store data that requires security in the operation of the semiconductor device 100B. Although the normal memory 277-1 and the secure memory 277-2 are separated from each other in an exemplary embodiment described with reference to FIG. 12, the normal memory 277-1 and the secure memory 277-2 may be formed in a single physical memory. For example, the memory 277 including the normal memory 277-1 and the secure memory 277-2 may be removably coupled to the semiconductor device 100B.

The structure and functions of the hardware secure module 210 illustrated in FIG. 12 may be the same as or similar to those of the hardware secure module 210 illustrated in FIG. 11. The I/O device 276-1 may include an input unit such as a touch pad, a keypad, an input button, or the like, and an output unit such as a speaker.

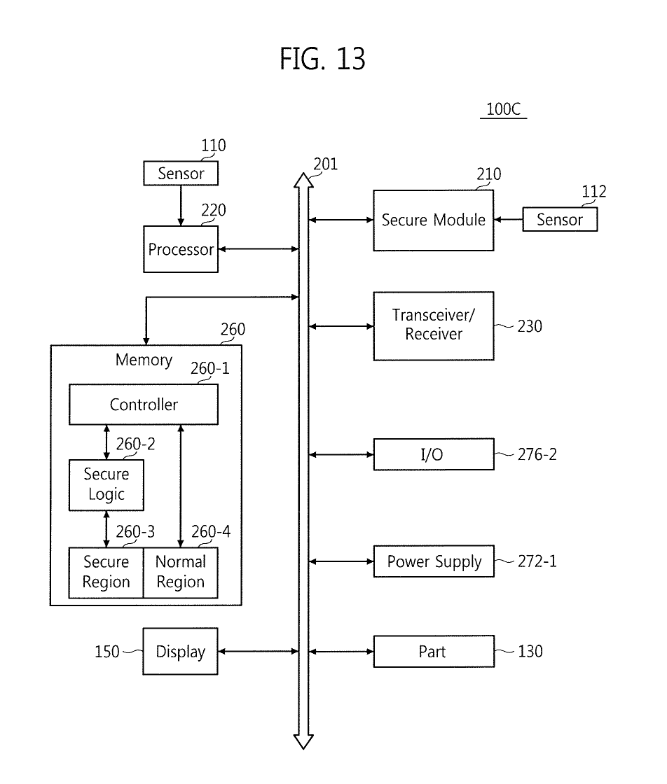

FIG. 13 is a block diagram of a device 100C for performing a self-diagnosis function according to an exemplary embodiment of the present inventive concept. Referring to FIGS. 1 and 13, the semiconductor device 100C may include the sensor 110, a sensor 112, the part 130, the display 150, the bus 201, the hardware secure module 210, the processor 220, the transceiver 230, a memory 260, a power supply 272-1, and an I/O device 276-2. The elements 110, 130, 150, 210, 220, 230, 260, 272-1, and 276-2 may communicate data with one another via the bus 201.

The processor 220 may control the overall operation of the semiconductor device 100C. The sensor 110 may transmit a detection signal to the processor 220. The sensor 112 may be a biosensor which detects biometric information. The structure and functions of the hardware secure module 210 illustrated in FIG. 13 may be the same as or similar to those of the hardware secure module 210 illustrated in FIG. 11.

The memory 260 may store a boot image for booting the semiconductor device 100C. For example, the memory 260 may be implemented as flash memory, SSD, eMMC, UFS, or the like. The memory 260 may include a secure region 260-3 and a normal region 260-4. A controller 260-1 may directly access the normal region 260-4, and may access the secure region 260-3 via a secure logic circuit 260-2. For example, the controller 260-1 can access the secure region 260-3 only via the secure logic circuit 260-2.

The hardware secure module 210 may store data output from the sensor 112 in the secure region 260-3 of the memory 260 through communication with the secure logic circuit 260-2 of the memory 260. The power supply 272-1 may provide an operating voltage necessary for the operation of the semiconductor device 100C. The I/O device 276-2 may include an input unit such as a touch pad, keypad, an input button, or the like, and an output unit such as a speaker.

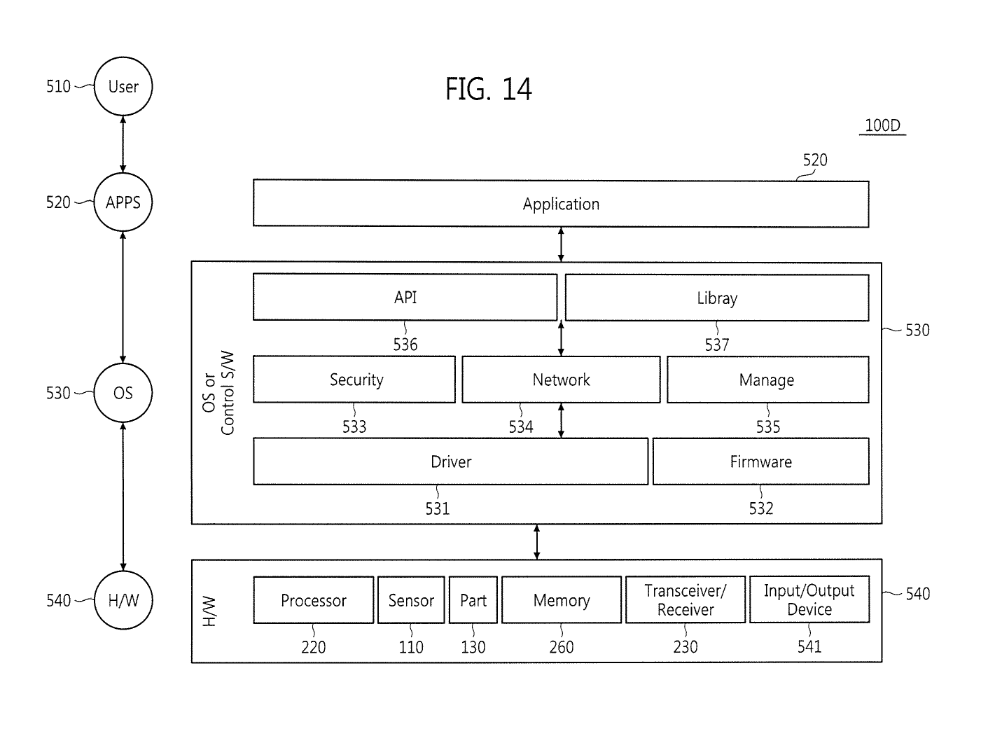

FIG. 14 is a block diagram of a device 100D for performing a self-diagnosis function according to an exemplary embodiment of the present inventive concept. Referring to FIGS. 1 and 14, the semiconductor device 100D may include various kinds of elements. The semiconductor device 100D may include the processor 220, the sensor 110, the part 130, the transceiver 230, the memory 260, and an I/O device 541. The semiconductor device 100D may further include an application 520 and an operating system (OS) 530. FIG. 14 shows a plurality of layers respectively corresponding to a user 510, the application 520, the OS 530, and hardware 540.

The application 520 may be software and/or service which performs a particular function. The user 510 may be a subject using the application 520. The user 510 may communicate with the application 520 using a UI.

The application 520 may be created based on a service purpose and may interact with the user 510 through a UI corresponding to the service purpose. The application 520 may perform an operation requested by the user 510, and may call an application protocol interface (API) 536 and the content of a library 537 if necessary.

The API 536 and/or the library 537 may perform a macro operation for a particular function. When communication with a lower layer is necessary, the API 536 and/or the library 537 may provide interface for the communication. When the application 520 requests a lower layer to operate through the API 536 and/or the library 537, the API 536 and/or the library 537 may classify the request as a security 533, a network 534, or a manage 535. The API 536 and/or the library 537 runs a layer corresponding to the request.

For example, when the API 536 requests a function related to the network 534, the API 536 may transmit a parameter necessary for the network 534 to the network 534 and may call the corresponding function. At this time, the network 534 may communicate with a corresponding lower layer to perform a requested task. When there is no lower layer, the API 536 and/or the library 537 may perform the task by itself.

A driver 531 may manage the hardware 540, and monitor the state of the hardware 540. The driver 531 may receive a classified request from an upper layer, and may deliver the request to the layer of the hardware 540.

When the driver 531 requests the layer of the hardware 540 to perform a task, firmware 532 may convert the request so that the layer of the hardware 540 can accept the converted request. The firmware 532, which transmits the converted request to the hardware 540, may be included in the driver 531. The firmware 532 may be executed by the hardware 540.

The semiconductor device 100D may include the API 536, the driver 531, and the firmware 532, and may be equipped with an OS that manages these elements. The OS may be stored in the memory 260 in a form of control command codes and data. When the semiconductor device 100D is a low-price product, the semiconductor device 100D may include control software instead of the OS since the size of the memory 260 is small.

The hardware 540 may execute requests (or commands) received from the driver 531 and/or the firmware 532, and may store the results of executing the requests in an internal register of the hardware 540 or in the memory 260. The results that have been stored may be returned to the driver 531 and/or the firmware 532.

The hardware 540 may generate an interrupt to request an upper layer to perform an operation. When the interrupt is generated, the interrupt is checked by the manage 535 of the OS 530 and processed by the hardware 540.

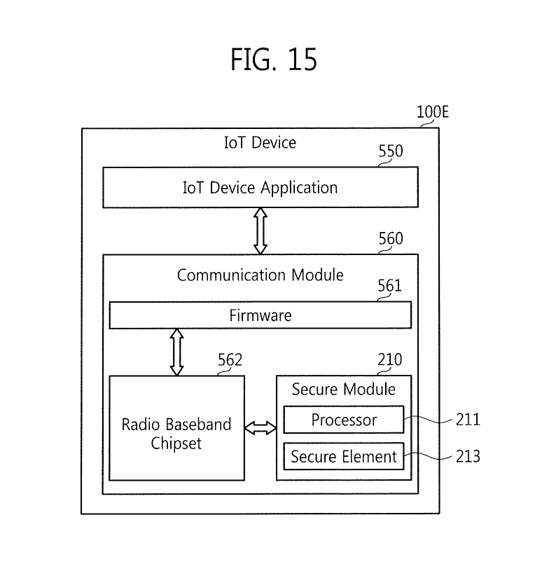

FIG. 15 is a block diagram of a device 100E for performing a self-diagnosis function according to an exemplary embodiment of the present inventive concept. Referring to FIGS. 1 and 15, the IoT device 100E may include an IoT device application 550 and a communication module 560. The communication module 560 may include firmware 561, a radio baseband chipset 562, and the hardware secure module 210.

The IoT device application 550, as a software component, may control the communication module 560. The IoT device application 550 may be executed by a central processing unit (CPU) of the IoT device 100E. The communication module 560 may perform communication via LAN, WLAN (e.g., Wi-Fi), WPAN (e.g., Bluetooth, wireless USB, ZigBee, NFC, RFID, PLC, or mobile cellular network. For example, the communication module 560 may be the transceiver 230.

The firmware 561 may provide the IoT device application 550 and application programming interface (API), and may control the radio baseband chipset 562 according to the control of the IoT device application 550. The radio baseband chipset 562 may provide connectivity of, e.g., the IoT device 100E, for a wireless communication network. The hardware secure module 210 may include a processor 211 and a secure element 213. The hardware secure module 210 may authenticate the IoT device 100E to connect the IoT device 100E to the wireless communication network or to access a wireless network service. The hardware secure module 210 may be implemented as an eMMC, but the present inventive concept is not restricted thereto.

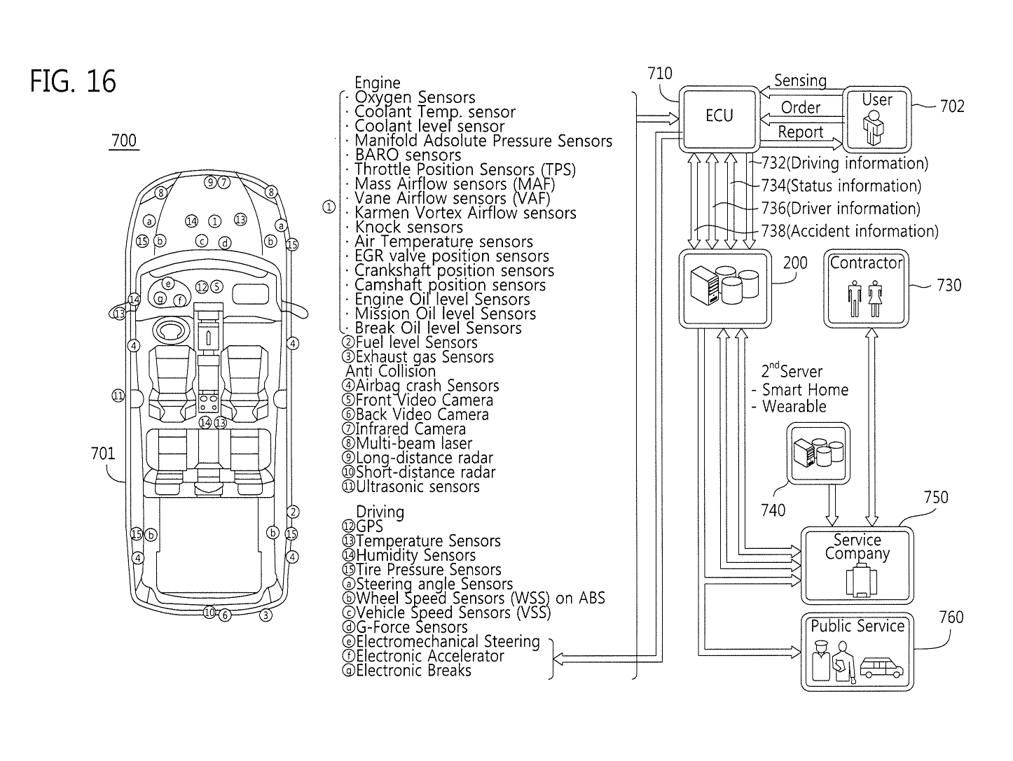

FIG. 16 is a block diagram of an IOT network system 700 for performing a self-diagnosis function according to an exemplary embodiment of the present inventive concept. Referring to FIGS. 1 through 7 and FIG. 16, the IoT network system 700 shows a usage scenario of vehicle management, collision prevention, vehicle driving service, or the like. Referring to FIG. 16, the IoT network system 700 includes a vehicle 701 including sensors. The IoT network system 700 may further include an engine control unit (ECU) 710, the self-diagnosis device 200, and at least one service provider 750 and/or 760. For example, the service providers 750 and 760 may perform operations the same as or similar to those performed by the big data analysis server 330 illustrated in FIG. 6.

The sensors may include an engine unit sensor \textcircled{1}, collision prevention sensors \textcircled{4} through \textcircled{11}, and vehicle driving sensors \textcircled{12} through \textcircled{15} and \textcircled{a} through \textcircled{g}. The sensors may further include a fuel level sensor \textcircled{2} and/or an exhaust gas sensor \textcircled{3}.

The ECU 710 may gather driving information 732 output from the sensors and may transmit the gathered driving information 732 to the self-diagnosis device 200 via a communication network. The self-diagnosis device 200 may perform the function of a data server. The self-diagnosis device 200 may be embedded in the data server.

The ECU 710 and the self-diagnosis device 200 may communicate vehicle status information 734, driver information 736, and/or accident information 738 with each other. Although the self-diagnosis device 200 is formed outside the ECU 710 in an exemplary embodiment described with reference to FIG. 16, the self-diagnosis device 200 may be formed inside the ECU 710 in an exemplary embodiment of the present inventive concept. The self-diagnosis device 200 may generate and send the first diagnosis report REPORT1 to a server of the service company 750.

The server of the service company 750 may provide a user's smart phone 702 information obtained by analyzing the vehicle 701 with reference to the vehicle status information 734, the driver information 736, and/or the accident information 738 stored in the self-diagnosis device 200. Services provided by the service company 750 may include information about accidents on the roads, a guide to the fast route, notification of accident handling, accident claim value calculation information, human-error rate estimation information, and/or emergency rescue service.

The server of the service company 750 may share vehicle-related information stored in the self-diagnosis device 200 with a user who has subscribed to the service. The user may make a contract with the service company 750 based on the shared vehicle-related information.

The server of the service company 750 may receive a driver's personal information from a second server 740, and may activate an access control and service function for the vehicle 701 of the driver using the driver's personal information. For example, the server of the service company 750 may receive NFC tag information stored in a user's wrist watch, compare the NFC tag information with NFC tag information stored in the second server 740, and unlock a door lock of the vehicle 701. The server of the service company 750 or the second server 740 may transmit arrival information of the vehicle 701 to an IoT device installed at the user's home when the vehicle 701 arrives at the user's home.

A server of the public service provider 760 may send traffic information to an IoT device (e.g., a smart phone of the driver of the vehicle 701) based on the accident information 738 stored in the self-diagnosis device 200.

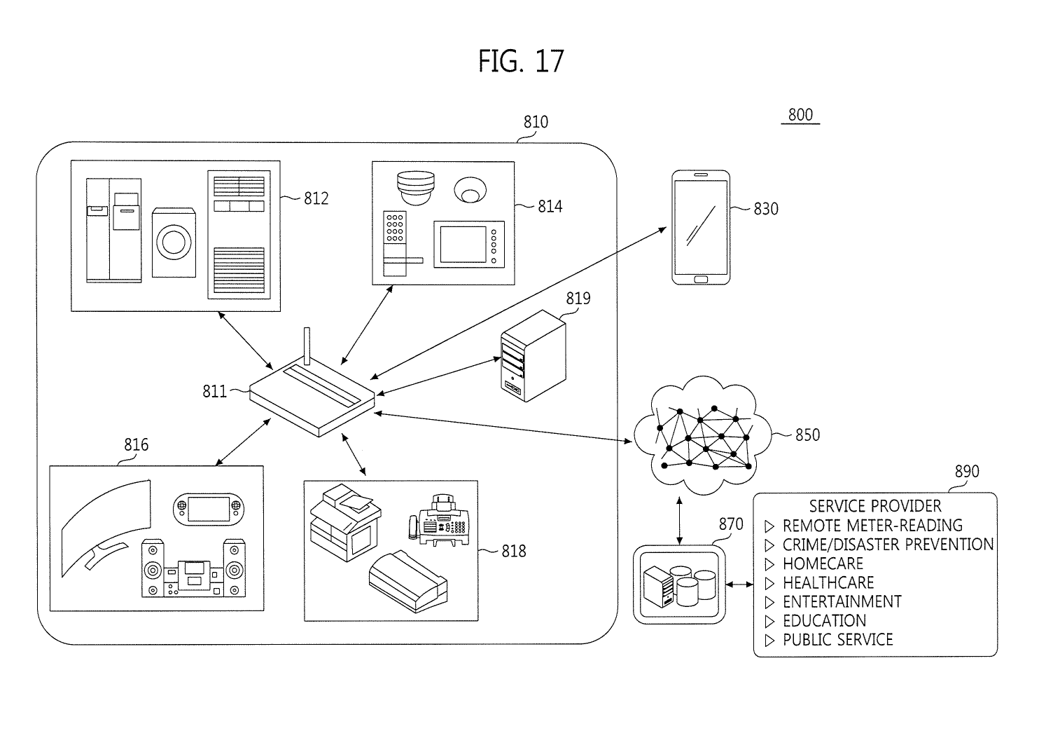

FIG. 17 is a block diagram of an IoT network system 800 (e.g., a data processing system) including the device 100 of FIG. 1 or 100-1 of FIG. 7 according to an exemplary embodiment of the present inventive concept. Referring to FIGS. 1 through 8, and FIG. 17, the IoT network system 800 may include a user's smart phone 830 and a home network system 810. The home network system 810 may include a plurality of IoT devices 812, 814, 816, and 818. The IoT network system 800 may further include a communication network 850, a server 870, and a service provider 890.

The home network system 810 may control various kinds of IoT devices in a building (e.g., a house, an apartment, a high-rise building, or the like) via a wired/wireless network, and may share contents with the IoT devices. The home network system 810 may include a hub 811, the IoT devices 812, 814, 816, and 818, and a home server 819. Each of the IoT devices 812, 814, 816, and 818 may include the sensors 110-1 through 110-n, the parts 130-1 through 130-n, and the self-diagnosis device 200. The home server 819 or the server 870 may perform operations the same as or similar to those performed by the big data analysis server 330 illustrated in FIG. 6.

The home appliance 812 may include a smart refrigerator, a smart washing machine, an air conditioner, or the like, but the present inventive concept is not restricted thereto. The security/safety equipment 814 may include a door lock, a CCTV, an interphone, a window sensor, a fire detection sensor, an electric plug, or the like, but the present inventive concept is not restricted thereto. The entertainment equipment 816 may include a smart TV, an audio unit, a game machine, a computer, or the like, but the present inventive concept is not restricted thereto. The office equipment 818 may include a printer, a projector, a copy machine, or the like, but the present inventive concept is not restricted thereto. Each of the elements 812, 814, 816, and 818 may be an IoT device.

Each of the IoT devices 812, 814, 816, and 818 may communicate with one another through the hub 811. Each of the IoT devices 812, 814, 816, and 818 may exchange detection data or control information with the hub 811. The IoT devices 812, 814, 816, and 818 may communicate with the hub 811 via a communication network. The home network system 810 may use a sensor network, an M2M network, an internet protocol (IP) based network, a non-IP based network, or the like. The home network system 810 may be implemented as a home phoneline networking alliance (PNA), IEEE1394, a USB, a PLC, Ethernet, infrared data association (IrDA), Bluetooth, Wi-Fi, WLAN, ultra wide band (UWB), ZigBee, wireless 1394, wireless USB, NFC, RFID, a mobile cellular network, or the like.

The IoT devices 812, 814, 816, and 818 may be connected to the communication network 850 through the hub 811 which functions as a home gateway. The hub 811 may convert a protocol between the home network system 810 and the communication network 850. For example, the hub 811 may convert a protocol among various types of communication networks included in the home network system 810, and may connect the IoT devices 812, 814, 816, and 818 with the home server 819.

The home server 819 may be installed at home or in an apartment block. The home server 819 may store or analyze data output from the hub 811. The home server 819 may provide a service corresponding to the analyzed information to at least one of the IoT devices 812, 814, 816, and 818 or the user's smart phone 830, or the home server 819 may transmit the analyzed information to the communication network 850 through the hub 811.

The home server 819 may receive and store external contents through the hub 811, may process data (e.g., the external contents), and may provide the processed data to at least one of the IoT devices 812, 814, 816, and 818 or the user's smart phone 830. Each of the IoT devices 812, 814, 816, and 818 may send the first diagnosis report REPORT1 to the hub 811. The first diagnosis report REPORT1 may be transmitted from the hub 811 to the server 870 via the communication network 850. Each of the IoT devices 812, 814, 816, and 818 may also send the second diagnosis report REPORT2 to the hub 811 or the user's smart phone 830. The hub 811 may provide the second diagnosis report REPORT2 to the user's smart phone 830.

The home server 819 may store I/O data transmitted from the security/safety equipment 814 or may provide an automatic security service or power management service to the IoT devices 812, 814, 816, and 818 based on the I/O data. When each of the IoT devices 812, 814, 816, and 818 includes a sensor for sensing luminance, humidity, contamination, or the like, the home server 819 may analyze data output from each IoT device 812, 814, 816, or 818 including the sensor, and may provide an environment control service according the analysis result or send the analysis result to the user's smart phone 830.

The communication network 850 may include an internet and/or or a public communication network. The public communication network may include a mobile cellular network. The communication network 850 may be a communication channel which transmits information gathered by the IoT devices 812, 814, 816, and 818 of the home network system 810.

The server 870 may store or analyze the gathered information, and may generate service information related to the analysis result or may provide the stored or analyzed information to the service provider 890 and/or the user's smart phone 830. The server 870 may analyze the second diagnosis report REPORT2.

The service provider 890 may analyze gathered information, and may provide various services to a user according to the analysis result. The service provider 890 may provide a service, such as a remote meter-reading, crime/disaster prevention, homecare, healthcare, entertainment, education, or civil service, to at least one of the IoT devices 812, 814, 816, and 818 or the user's smart phone 830.

The service provider 890 may receive information generated by at least one of the IoT devices 812, 814, 816, and 818 from the server 870, and may provide a service of remotely reading information related to an energy resource (e.g., gas, water, or electricity) based on the received information. The service provider 890 may receive information generated by at least one of the IoT devices 812, 814, 816, and 818 from the server 870, may generate energy resource-related information, indoor environment information, or user status information based on the received information, and may provide the generated information to at least one of the IoT devices 812, 814, 816, and 818 or the user's smart phone 830.

The service provider 890 may provide an emergency rescue service for crime/disaster prevention based on security-related information, information about fire outbreak, safety-related information, or the like. The service provider 890 may send the information (e.g., the security-related information, the information about the fire outbreak, the safety-related information) to the user's smart phone 830. The service provider 890 may further provide an entertainment, education or administration service based on information received from at least one of the IoT devices 812, 814, 816, and 818, and may provide a two-way service through at least one of the IoT devices 812, 814, 816, and 818.

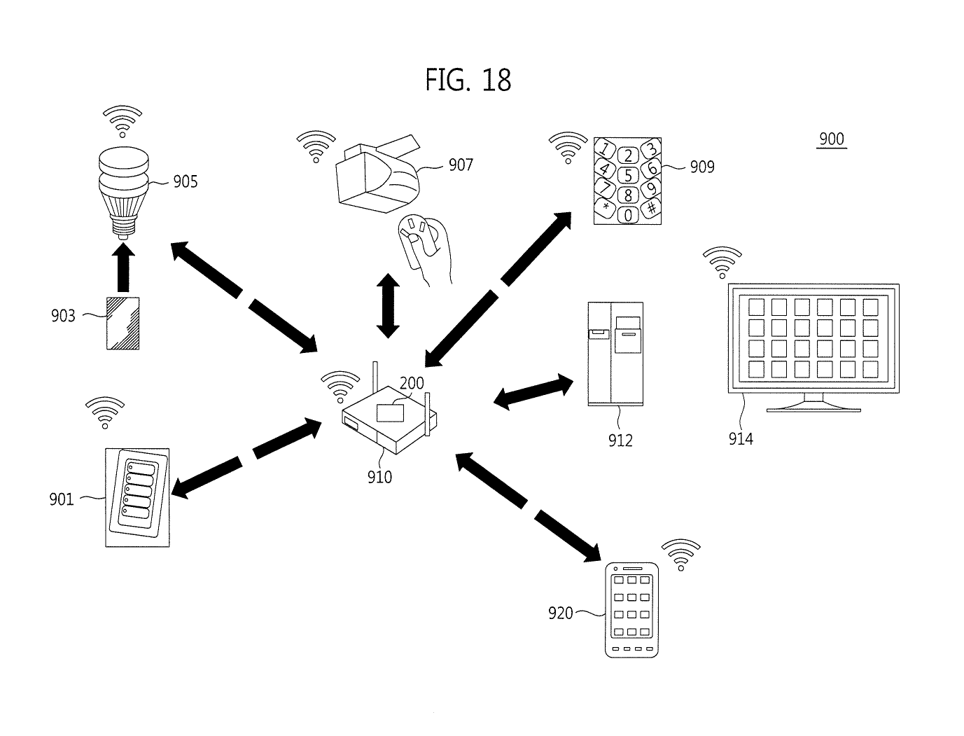

FIG. 18 is a block diagram of an IOT network system 900 (e.g., a data processing system) including the device 100 of FIG. 1 or 100-1 of FIG. 7 according to an exemplary embodiment of the present inventive concept. Referring to FIGS. 1 through 7 and FIG. 18, the IoT network system 900 may be a smart lighting-network system which controls a light emitting device (e.g., a light emitting diode (LED)). The IoT network system 900 may be formed using various kinds of lighting fixtures and wired/wireless communication devices. The IoT network system 900 may include a sensor, a controller, a communication unit, and a software component (e.g., software for network control and maintenance).

The IoT network system 900 may be used in a closed space defined as an inside of a building, such as home, an office, or the like. The IoT network system 900 may be used in an open space, such as a park, a street, or the like. The IoT network system 900 may be implemented to gather and/or process various kinds of information output from at least one sensor, and the IoT network system 900 may provide the information to a user's smart phone 920.

An LED lamp 905 included in the IoT network system 900 may receive information about a surrounding environment from a hub 910 or the user's smart phone 920 and may control light of the LED lamp 905 based on the information. The LED lamp 905 may check and control the operation state of at least one of IoT devices 901, 903, 907, 909, 912, and 914 included in the IoT network system 900 based on a communication protocol (e.g., a visible light communication protocol) of the LED lamp 905. The self-diagnosis device 200 may be formed in the hub 910, and a sensor and a part may be formed in each of the elements 901, 903, 905, 907, 909, 912, and 914. The hub 910 may perform operations the same as or similar to those performed by the big data analysis server 330 illustrated in FIG. 6.

The IoT network system 900 may include the hub 910, the user's smart phone 920 paired with the hub 910, the LED lamp 905, and the IoT devices 901, 907, 909, 912, and 914. The hub 910 may perform the function of a gateway of processing data transferred according to different communication protocols. The LED lamp 905 may communicate with the hub 910 and may include a light emitting element. The IoT devices 901, 907, 909, 912, and 914 may communicate with the hub 910 according to various kinds of radio communication methods. Each of the IoT devices 901, 907, 909, 912, and 914 may be the semiconductor device 100 illustrated in FIG. 1. The LED lamp 905 may include a lamp communication module 903, which may function as the transceiver 230. Each of the IoT devices 901, 907, 909, 912, and 914 may include the light switch 901, the garage door lock 907, the digital door lock 909, the refrigerator 912, and the TV 914.

In the IoT network system 900 of FIG. 18, the LED lamp 905 may check the operation status of at least one of the IoT devices 901, 907, 909, 912, and 914 using a radio communication network or may automatically adjust its own luminance according to a surrounding environment or circumstance. In addition, the LED lamp 905 may control the operation of at least one of the IoT devices 901, 907, 909, 912, and 914 using LED Wi-Fi (LiFi) using visible rays emitted from the LED lamp 905.

The LED lamp 905 may automatically adjust its own luminance based on surrounding environment information transmitted from the hub 910 or the user's smart phone 920 through the lamp communication module 903. In an exemplary embodiment of the present inventive concept, the LED lamp 905 may automatically adjust its own luminance based on surrounding environment information gathered from a sensor attached to the LED lamp 905. For example, the brightness of the LED lamp 905 may be automatically adjusted according to the type of a program on the TV 914 or the brightness of the screen of the TV 914. For this operation, the LED lamp 905 may receive operation information of the TV 914 through the lamp communication module 903 which is wirelessly connected with the hub 910 or the user's smart phone 920. The lamp communication module 903 may be integrated with a sensor included in the LED lamp 905 and/or a controller included in the LED lamp 905 into a module.

When a predetermined period of time elapses after the digital door lock 909 is locked with no one at home, the LED lamp 905 can be turned off according to the control of the hub 910 or the user's smart phone 920. Thus, power consumption is reduced. When a security mode is set according to the control of the hub 910 or the user's smart phone 920, the LED lamp 905 is maintained in an on-state even if the digital door lock 909 is locked with no one at home.

On or off-state of the LED lamp 905 may be controlled according to surrounding environment information gathered through sensors included in the IoT network system 900. The LED lamp 905, which includes at least one sensor, a storage device, and the lamp communication module 903, may keep a building secure or may detect an emergency. For example, when the LED lamp 905 includes a sensor for detecting smoke, CO₂, temperature, or the like, the LED lamp 905 may detect fire and output a detection signal through an output unit of the LED lamp 905 or send the detection signal to the hub 910 or the user's smart phone 920.

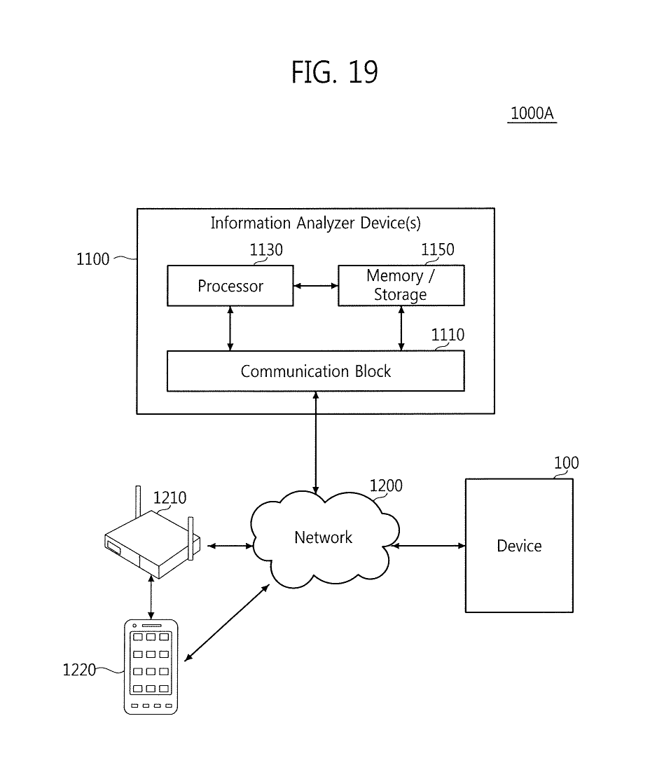

FIG. 19 is a block diagram of an IoT network system 1000A (e.g., a data processing system) including the device 100 of FIG. 1 or 100-1 of FIG. 7 according to an exemplary embodiment of the present inventive concept. Referring to FIGS. 1 through 7 and FIG. 19, the IoT network system 1000A may be implemented as a service system providing services to users. The IoT network system 1000A may include a hub 1210, a user's smart phone 1220, a communication network 1200, an information analyzer device 1100, and the semiconductor device 100.

The user's smart phone 1220 may be used by a subject (e.g., a user) who requests at least one service. For example, a user may request a service using the smart phone 1220 and provided with the service.

The semiconductor device 100 may generate the first or second diagnosis report REPORT1 or REPORT2 and transmit the first or second diagnosis report REPORT1 or REPORT2 to the information analyzer device 1100 or the user's smart phone 1220 via the communication network 1200.

The information analyzer device 1100 may analyze information (e.g., the first or second diagnosis report REPORT1 or REPORT2) to provide a service. The information analyzer device 1100 may analyze the information necessary to achieve the goal of the service. For example, the information analyzer device 1100 may receive and analyze the first diagnosis report REPORT1. The information analyzer device 1100 may include a universal computer such as a PC and/or a dedicated computer such as a workstation. The information analyzer device 1100 may include at least one computing device. For example, the information analyzer device 1100 may include a communication block 1110, a processor 1130, and a memory/storage 1150.

The communication block 1110 may communicate with the user's smart phone 1220 and/or the semiconductor device 100 via the communication network 1200. The user's smart phone 1220 and/or the semiconductor device 100 may provide information and data to the communication block 1110 through the communication network 1200. The communication block 1110 may transmit results necessary to provide the service to the user's smart phone 1220 and/or the semiconductor device 100 through the communication network 1200. The processor 1130 may receive and process the information and data and outputs the processing result to provide the service. The memory/storage 1150 may store data that has been processed or will be processed by the processor 1130.

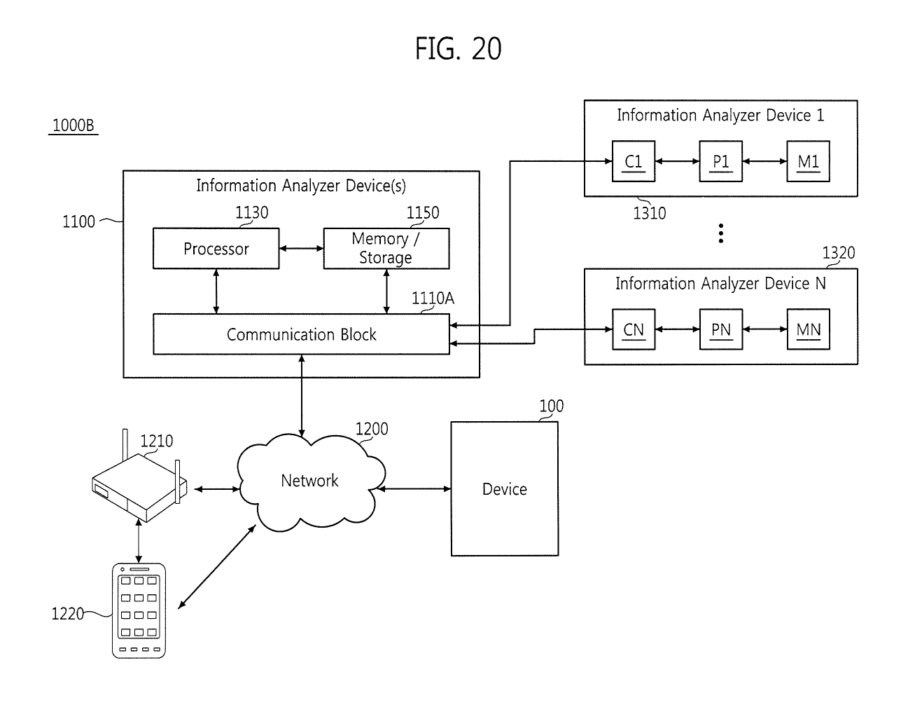

FIG. 20 is a block diagram of an IoT network system 1000B (e.g., a data processing system) including the device 100 of FIG. 1 or 100-1 of FIG. 7 according to an exemplary embodiment of the present inventive concept. Referring to FIGS. 1 through 7 and FIGS. 19 and 20, the IoT network system 1000B may include the hub 1210, the user's smart phone 1220, the communication network 1200, the information analyzer device 1100, the semiconductor device 100, and information analyzer devices 1310 through 1320. The semiconductor device 100 may generate the first or second diagnosis report REPORT1 or REPORT2 and transmit the first or second diagnosis report REPORT1 or REPORT2 to the information analyzer device 1100 or the user's smart phone 1220 via the communication network 1200. Except that the IoT network system 1000B includes the information analyzer devices 1310 through 1320, the IoT network system 1000B illustrated in FIG. 20 is the same as or similar to the IoT network system 1000A illustrated in FIG. 19.

While the IoT network system 1000B of FIG. 20 includes the information analyzer device 1100, the IoT network system 1000B may further include the information analyzer devices 1310 through 1320. The first information analyzer device 1310 may include a communication block C1, a processor P1, and a memory/storage M1, and the N-th information analyzer device 1320 may include a communication block CN, a processor PN, and a memory/storage MN.

The structure and operations of each of the information analyzer devices 1310 through 1320 may substantially be the same as or similar to those of the information analyzer device 1100 illustrated in FIG. 20. Each of the information analyzer devices 1310 through 1320 may analyze information necessary to provide a service for a user.

The information analyzer device 1100 may manage the operation of the information analyzer devices 1310 through 1320. The information analyzer device 1100 may distribute information or data subjected to analysis to the information analyzer devices 1310 through 1320. Information necessary to provide a service for a user may be processed in the information analyzer devices 1100 and 1310 through 1320 in a distributed fashion. For example, the information analyzer devices 1100 and 1310 through 1320 may analyze the first diagnosis report REPORT1. The information analyzer devices 1100 and 1310 through 1320 may perform operations the same as or similar to those performed by the big data analysis server 330 illustrated in FIG. 6.

The information analyzer device 1100 may include a communication block 1110A, the processor 1130, and the memory/storage 1150. The information analyzer device 1100 may communicate, through the communication block 1110A, with each of the communication blocks C1 through CN which are respectively included in the information analyzer devices 1310 through 1320. In addition, the information analyzer device 1100 may communicate with other elements 1210, 1220, and 100 through the communication block 1110A. The information analyzer device 1100 may manage and schedule analysis and/or processing of the information which are performed by the information analyzer devices 1310 through 1320 according to the operations of the processor 1130 and the memory/storage 1150.

As described above, according to an exemplary embodiment of the present inventive concept, a semiconductor device including a part and a self-diagnosis device is able to automatically cure an anomaly of the part. The semiconductor device can automatically transmit the abnormal symptom of its part and the expected replacement time of the part to an AS center server, so that a user does not need to inquire of an AS center about the abnormal symptom and the expected replacement time of the part included in the semiconductor device. Accordingly, cost of running the AS center is reduced.

Since the semiconductor device automatically transmits the abnormal symptom of its part and the expected replacement time of the part to the AS center server, the number of times that a technician in the AS center visits a place where the semiconductor device is installed is reduced and a time taken to repair the semiconductor is reduced. In addition, a manufacturer can analyze the abnormal symptom and the expected replacement time of the part of the semiconductor device using a big data analysis server, and thus, the manufacturer may efficiently manage the part or the semiconductor device including the part and may obtain information which is used for increasing the quality of the part or the semiconductor device including the part.

The manufacturer can perform SCM using the analysis result of the big data analysis server and make a prediction about an amount of supply of the part included in the semiconductor device. When it takes a relatively long time to repair the semiconductor device which malfunctions, the manufacturer may lease out a same model as the malfunctioning semiconductor device.

While the present inventive concept has been particularly shown and described with reference to exemplary embodiments thereof, it will be understood by those of ordinary skill in the art that various changes in forms and details may be made therein without departing from the spirit and scope of the present inventive concept as defined by the following claims.

What is claimed is:

1. A semiconductor device including a component and a self-diagnosis device,
wherein the self-diagnosis device comprises:
a hardware secure module configured to store a self-diagnosis policy for the component; and
a processor configured to receive a detection signal output from a sensor, to diagnose a state of the component using the detection signal and the self-diagnosis policy stored in the hardware secure module, and to generate a control signal for controlling the state of the component according to the diagnosed state.

2. The semiconductor device of claim 1, wherein the hardware secure module stores a digital signature of a user of the semiconductor device, and
wherein the processor is configured to generate a diagnosis report including the digital signature according to the diagnosed state.

3. The semiconductor device of claim 1, wherein the self-diagnosis policy comprises at least two among a sensing type, a sensing method, a condition, or a cure activity, and
wherein the processor is configured to generate a diagnosis report including at least one among an abnormal symptom of the component or an expected replacement time of the component.

4. The semiconductor device of claim 3, further comprising a communication module configured to transmit the diagnosis report generated by the processor to an external communication device.

5. The semiconductor device of claim 1, further comprising a display driver,
wherein the processor is configured to generate a second diagnosis report including at least one among an abnormal symptom of the component or an expected replacement time of the component based on the diagnosis result, and
wherein the display driver is configured to transmit the second diagnosis report generated by the processor to a display in the semiconductor device.

6. The semiconductor device of claim 5, further comprising:
a touch screen controller configured to generate user data corresponding to a user input received through a touch screen of the semiconductor device; and
a communication module,
wherein the processor is configured to generate a first diagnosis report including an identification number of the component based on the second diagnosis report in response to the user data, and to control the communication module to transmit the first diagnosis report to an external communication device.

7. The semiconductor device of claim 1, wherein the component is configured to control a position of the semiconductor device.

8. The semiconductor device of claim 1, wherein when the component is in an abnormal state, the processor is configured to generate the control signal for curing the abnormal state of the component according to the diagnosed state.

9. The semiconductor device of claim 1, further comprising a communication module configured to receive a new self-diagnosis policy from an external communication device,
wherein the processor is configured to update the self-diagnosis policy stored in the hardware secure module with the new self-diagnosis policy.

10. The semiconductor device of claim 9, wherein the self-diagnosis policy or the new self-diagnosis policy comprises external environment information regarding the semiconductor device.

11. An internet of things (IoT) device comprising:
a communication module;
a component;
a sensor; and
a self-diagnosis device,
wherein the self-diagnosis device includes:
a hardware secure module configured to store a self-diagnosis policy for the component; and
a processor configured to receive a detection signal output from the sensor, to diagnose a state of the component using the detection signal and the self-diagnosis policy stored in the hardware secure module, and to generate a first diagnosis report including at least one among an abnormal symptom of the component or an expected replacement time of the component according to the diagnosed state.

12. The IoT device of claim 11, wherein the hardware secure module is configured to store a digital signature of a user of the IoT device, and
wherein the processor is configured to generate the first diagnosis report including the digital signature according to the diagnosed state, and to control the communication module to transmit the first diagnosis report including the digital signature to an external communication device.

13. The IoT device of claim 11, wherein the self-diagnosis policy comprises at least two among a sensing type, a sensing method, a condition, or a cure activity,
wherein the processor is configured to generate a control signal for controlling the state of the component according to the diagnosed state.

14. The IoT device of claim 13, wherein when the component is in an abnormal state, the processor is configured to generate the control signal for curing the abnormal state of the component according to the diagnosed state.

15. The IoT device of claim 11, wherein the communication module is configured to receive a new self-diagnosis policy from an external communication device, and
wherein the processor is configured to update the self-diagnosis policy stored in the hardware secure module with the new self-diagnosis policy.

16. A data processing system comprising:
a semiconductor device including a processor, a component, a sensor generating a detection signal corresponding to the component, a transceiver, and a memory;
a hub including a diagnosis device generating a first diagnosis report in response to the detection signal, the hub being disposed outside the semiconductor device; and
a server receiving the first diagnosis report from the hub through a network,
wherein the processor receives the detection signal output from the sensor, and transmits the detection signal to the hub through the transceiver.

17. The data processing system of claim 16, wherein the first diagnosis report includes at least one among an abnormal symptom of the component or an expected replacement time of the component.

18. The data processing system of claim 16, wherein the hub further includes a hardware secure module storing a self-diagnosis policy.

19. The data processing system of claim 18, wherein the server generates a new self-diagnosis policy based on the first diagnosis report, and sends the new self-diagnosis policy to the processor.

20. The data processing system of claim 19, wherein the processor updates the self-diagnosis policy stored in the hardware secure module with the new self-diagnosis policy.
